(19) United States
(12) Patent Application Publication
(10) Pub. No.: US 2026/0212847 A1
(43) Pub. Date: Jul. 23, 2026

(54) A SYSTEM FOR, AND A METHOD OF, FACILITATING MUSIC COMPOSITION AND MUSIC PERFORMANCE

(71) Applicant: JABRIFFS LIMITED, Dublin 18 (IE)

(72) Inventor: James Anthony BARRY, Dublin 18 (IE)

(73) Assignee: JABRIFFS LIMITED, Dublin 18 (IE)

(21) Appl. No.: 19/140,158

(22) PCT Filed: Dec. 14, 2023
(86) PCT No.: PCT/EP2023/085907

§ 371 Date: Jun. 17, 2025

(30) Foreign Application Priority Data
Dec. 19, 2022 (IE) S2022/0205

(51) Int. Cl. G10H 1/00; G06F 3/16; G10H 1/28

(52) U.S. Cl. CPC G10H 1/0025; G06F 3/162; G06F 3/165; G10H 1/0066; G10H 1/28; G10H 2210/105; G10H 2210/185; G10H 2210/571; G10H 2220/086; G10H 2220/126; G10H 2220/131; G10H 2240/175; G10H 2240/311

(57) ABSTRACT

The present invention relates to a system for facilitating music composition and performance, including: a chord selection matrix area, configured to receive and assign notes of a selected chord, said selected chord representing a scale degree position and chord value within a calculated musical key or key combination; a plurality of arpeggiator panes associated with said chord selection matrix area, each arpeggiator pane configured to receive the assigned notes of said selected chord; an interactive and real-time adjustment means to enable modification of note patterns and sequences applied to said selected chord notes; and a routing mechanism, to route the MIDI data stream originated from any individual creation area to independently pair with an individual instrument or Musical Instrument Digital Interface (MIDI) track in a Digital Audio Workstation (DAW) running locally, or independently pair with an individual track of a connected external MIDI-capable device for simultaneous playback.

### BACKGROUND TO THE INVENTION

In particular, the present invention is an improvement to the invention disclosed in U.S. Pat. No. 10,614,786 by the same inventor.

U.S. Pat. No. 10,614,786 discloses a computer system with a touch screen device, data processors, and computer-readable storage media containing a software application. The software application performs operations including: displaying a chord selection matrix template associated with a musical key or key combination, allowing users to select chords, displaying a chord scale degree timeline associated with a selected digital musical file, indicating the scale, degree, position and chord value for each chord; generating the chord scale degree timeline based on a chord file associated with the selected music file, containing identified parameters, including chords and a timeline; assigning notes to each chord element based on user selections and a chord assignment file; allowing users to configure virtual or physical instrument sounds; receiving triggering inputs associated with selected chord elements and playing audio sounds associated with the activated notes.

Key features of U.S. Pat. No. 10,614,786 include: a touch screen device with a user interface for chord selection and musical composition, a chord scale degree timeline generated based on a chord file associated with the music file, configuration of virtual or physical instrument sounds based on user selections and chord assignment files, user interface elements for selecting chord selection matrix templates and configuring layouts, and options for auto play and auto display to assist users in learning and practicing.

Those in the industry will appreciate that music composition and instrument playing are skills developed through dedication and continuous learning and practice, over a long period of time, and the process has many pain points. Music contains melody, harmony, rhythm, timbre, pitch, silence, expression, and structure. Although there are only twelve music notes, they can be combined and played in endless combinations and patterns. Music compositions have structure. Compositions can be harmonic and melodic. Individual notes have stresses and releases. Music has mood. It has movement.

Fundamental to music is rhythm. Rhythm is the most important component of music. Rhythm is “patterns in time”. Rhythm can exist without melody as with drumbeats, but melody cannot exist without rhythm. Rhythm is therefore widely regarded as the keystone of music creation. It is based on repeating patterns of notes and silences (rests) and note emphasis. Notes can vary in pitch, duration, and intensity in repeating patterns. Rhythm can also be generated by varying the number or notes or rests played for each beat or combination of beats. For a user to play repeating rhythmic patterns in the correct order and in sync with a beat, at different tempos, requires dexterity and muscle memory which takes a significant amount of time to develop. The reason is that individual notes in a pattern will vary in note value, pitch, duration, and intensity. Developing proficiency in these skills therefore requires real dedication and a significant time commitment to repetitive practice and theory learning.

Musicians will advise that note relationships are prescribed by scales, keys, modes, chords, consonance, and dissonance, and much more. Advanced music theory knowledge is therefore required to understand these complicated note relationships. This takes considerable dedication and time to master.

In many compositions, music notes are combined to be played simultaneously as chords. Chords are usually played in sequences, known as chord progressions. These chord progressions are the foundation of most musical creations, and a good chord progression often provides the inspiration for the development of a great song. However, it is to be appreciated that even experienced musicians can have difficulty effecting chord changes in sync with a beat, such as a downbeat.

In terms of existing technologies for music composition and performance, the proliferation of free and affordable Digital Audio Workstations (DAWs) has made it the most popular platform for composing music, and it is widely used today by bedroom producers, social media creators, podcasters, songwriters, right up to professional music producers.

DAWs and its accompanying hardware are widely available today and are capable of supporting a wide range of virtual instrument sounds. These systems provide the platform to allow users at all levels of musical knowledge and playing ability to create and perform very complex musical compositions.

The above notwithstanding, the hurdles presented to the composition and performance of truly authentic music that has movement and mood, using a DAW, are very challenging to overcome and can sometimes be overwhelming for users. Even users with advanced music theory knowledge and some playing ability, find it difficult.

To understand the problem, we need to look at the specifics. The architecture of the DAW has changed little since its inception. The basic layout presents the user with multiple tracks displayed along a timeline which can be configured as audio tracks, virtual instrument tracks, Musical Instrument Digital Interface (MIDI) tracks or effects tracks. Users are provided with the facility to edit the media within a track or to edit the MIDI content of a virtual instrument or MIDI track. There are also facilities provided to add effects or other refinements to individual tracks or to a composite musical mix. Here, the application will typically interact with instruments or MIDI tracks in a DAW or with any other MIDI-capable playing device, which is connected.

A MIDI protocol is a protocol that allows electronic musical instruments, computers, and other devices to communicate with each other. A MIDI protocol also allows electronic instruments to communicate with virtual instruments which may be supported in DAW software. More particularly, MIDI comprises a set of defined instructions, or MIDI messages, telling a compatible instrument which notes to play, how hard to strike them and at what tempo and relative volume to play each note.

The piano roll is a popular feature in most DAWs that allows users to configure and sequence MIDI information in instrumental and MIDI tracks. The piano roll is provided in the form of a virtual grid representing time on the horizontal axis and MIDI notes (displayed as a piano keyboard layout) on the vertical axis. The piano roll is typically used to write chord progressions and note sequences for instruments and MIDI tracks. The piano roll can also be used to edit notes, add, and delete notes, and edit MIDI data.

Similarly, users can manually create rhythmic patterns using the step sequencers that are provided with most DAWs or using an external, MIDI-capable device. A step sequencer is exemplified as a virtual grid of 16 steps across one axis. The step sequencer is a grid-based interface that allows users to program beats by placing individual note steps along the axis.

There are other ways to arrange rhythm patterns in a DAW. For example, some DAWs offer a drum machine interface that emulates the look and feel of classic drum machines. In turn, others provide audio loops that can be arranged and edited to create new rhythms.

Virtual instruments, in turn, are software programs designed to simulate the sound of physical instruments, such as: pianos, drums, percussion instruments, string instruments, wind instruments, and synthesizers. Virtual instruments can also simulate the sound of many different ethnic instruments as well as a range of other effect sounds. Most DAWs also allow for a third-party plug-ins to, for example, a digital sound library.

One option currently available to creators, performers and producers wanting to play a virtual instrument or MIDI track in a DAW is to connect an external MIDI device, be it a MIDI keyboard, a MIDI sequencer, a MIDI drum pad, et al, and assign it to tracks in the DAW. It will be appreciated by those in the industry, that with this option the user is however required to have music theory knowledge and playing ability to play chords and note patterns on an external MIDI keyboard.

Another option is to use the piano roll. In terms of this process, users must paint the chord progressions and note patterns manually. It is to be appreciated that this option requires the user to have at least some music theory knowledge.

It will be appreciated by those in the industry, that using a piano roll or step sequencer to develop chord progression and note sequences for individual instrument tracks that are melodic and rhythmic allows for limited creative expression, is tedious and time consuming and requires some theoretical knowledge of chord structures, key signatures, and musical scales, that is beyond the reach of most music creators today.

Furthermore, creating beats, patterns and sequences with a software sequencer is time consuming and does not facilitate interactive real-time intervention when playing or recording multiple tracks with a DAW.

Similarly, setting up static patterns and sequences using the software arpeggiators currently provided in a DAW is also tedious, allows limited expression and does not facilitate interactive real-time intervention when playing or recording multiple tracks with a DAW.

Those skilled in the art will appreciate that the existing solutions offered today, which are intended to make music creation and performance quicker and easier for users and provide a better workflow using a DAW, generally removes a lot of the creativity, expression, musical nuance and emotional engagement from the process. As such, these forms of musical composition and performance are robotic and lack human inspired energy and passion. Users end up buying more chord progression packs, more plugins, more sample bundles, more arpeggios, and more advanced sequencers, only to be left with the same lack of authenticity. For original creations and performances, users must be engaged, in real-time, with the rhythm of the music. The user must be able to move their body, bob their head, shout out, wave their arms, and fully express their emotions whilst creating the music.

Moreover, it is to be appreciated that when a user uses a music creation tool or utility, they should be enhancing their music theory and music composition knowledge and skills in the process.

It will be appreciated by those in the industry, that a need exists for both novice and experienced creators and musical performers to create and perform innovative and compelling rhythms, melodies and harmonies, interactively and in real-time using a DAW, synthesiser or another MIDI-capable playing device, almost instantaneously. In other words, without the aid of any external MIDI keyboards, sequencers or drum pads and independently of a piano roll or any other sequencers provided in the DAW, whilst painlessly absorbing the musical concepts essential to longer-term composition success.

A MIDI keyboard transmits a single MIDI message stream for each individual Key press on the keyboard. The MIDI message stream will be recognised by any assigned instrument track in a DAW. If a user wishes to simultaneously play different selections of virtual instrument sounds, triggered by different note patterns and sequences, with different note parameters assigned will require the user to connect separate external MIDI devices, independently paired to individual instrument tracks of a DAW, for each individual instrument sound. This is a costly exercise and is not practical for a sole user to interact with multiple devices simultaneously.

Such a software application should ideally allow a user to compose and play meaningful original compositions using any virtual instrument or instrumental sound supported in a DAW, when connected with a MIDI enabled synthesiser or when connected to any MIDI-capable playing device. In other words, quickly and easily, without the aid of any external MIDI keyboards, sequencers or drum pads and independently of a piano roll or sequencers provided in the DAW. This composition should be able to take place irrespective of whether the user has none, some, or advanced music theory knowledge or are a beginner or accomplished musician.

Accordingly, in the view of the foregoing complexities, it is an object of the present invention to provide a system for and a method of facilitating music composition and performance, which overcomes the drawbacks of known solutions or at least provides a suitable alternative.

### SUMMARY OF THE INVENTION.

The present invention addresses the problems currently faced in facilitating music composition and performance using a conventional DAW and related, existing technologies. More particularly, the invention overcomes the problem of facilitating instantaneous and intuitive music composition and the playing of meaningful original compositions using a DAW, where the patterns and sequences can be changed and adjusted interactively, and in real time, and the facility is provided to independently route or pair the generated MIDI data stream, with one, many, or all connected external MIDI capable devices so that the music can be played on multiple virtual instruments simultaneously.

These problems are solved by a system for facilitating music composition and performance which includes one or more of the following features: a chord selection matrix which allows users to select chords representing scale degree positions and chord values within calculated musical keys, arpeggiator panes to generate melodies, harmonies, beats, and instrument solos by arranging assigned notes of selected chords in various patterns and sequences and real-time adjustment through an interactive modification of note patterns and sequences for selected chords during composition and performance as well as a routing mechanism, operable to route the MIDI data stream originated from any individual creation area to independently pair with an individual instrument or Musical Instrument Digital Interface (MIDI) track in a Digital Audio Workstation (DAW) running locally, or independently pair with individual tracks of connected external MIDI-capable devices for simultaneous playback.

The invention relates to a system for, and a method of, facilitating music composition and performance.

The invention is set out in the claims.

Accordingly, a first aspect of the present invention is a system for facilitating music composition and performance, including one or more of the following:
a chord selection matrix area, operatively configured to receive and assign notes of a selected chord, said selected chord representing a scale degree position and chord value within a calculated musical key or key combination;
a plurality of arpeggiator panes associated with said chord selection matrix area, each arpeggiator pane being operatively configured to receive the assigned notes of said selected chord, wherein said assigned notes are arranged in patterns and sequences to generate one or more melodies, harmonies, beats, or instrument solos;
an interactive and real-time adjustment means operable to enable modification of note patterns and sequences applied to said selected chord notes; and
a routing mechanism, operable to route the MIDI data stream originated from any individual creation area to independently pair with an individual instrument or Musical Instrument Digital Interface (MIDI) track in a Digital Audio Workstation (DAW) running locally, or independently pair with individual tracks of connected external MIDI-capable devices for simultaneous playback.

In an embodiment of the invention, the MIDI data streams may be associated with one or more of the following: an individual arpeggiator pane with an individual instrument or MIDI track of a DAW, a selected chord in the chord selection matrix area, one or more control member activations in a virtual instrument playing area, a MIDI track of a locally running DAW or an individual track of a connected external MIDI-capable device.

Additionally, or alternatively, the chord selection matrix area may include a visual metronome, operable to provide synchronization options for chord changes, arpeggio patterns, or instrument activations with a selected beat such as a downbeat, to enhance rhythmic precision within a music composition.

In an embodiment, the arpeggiator panes include a play-through feature allowing simultaneous playback of notes from a selected chord in the chord selection matrix area and arpeggios in the arpeggiator panes, to facilitate composition evaluation.

In a preferred embodiment of the invention, the interactive and real-time adjustment means includes a visual interface operable to display one or more of the following: note configurations, chord progressions, or arpeggio configurations, to enable dynamic modification during music composition and performance.

In embodiments, the invention as disclosed, references multiple creation areas, including one or more of the following: a chord selection matrix area, a virtual piano and/or guitar playing area as disclosed in the earlier US Granted U.S. Pat. No. 10,614,786, and multiple arpeggiator creation areas with associated chord pattern and sequence arrangement areas, as described herein.

In embodiments of the invention, the distribution of assigned notes to arpeggiator panes allows configuration and arrangement of patterns and sequences for generating novel and compelling melodies, harmonies, beats, or instrument solos with rhythm, movement, flow, variety, and interest.

Advantageously, the routing mechanism provides a versatile MIDI destination configuration, to enable a selection of virtual MIDI ports, MIDI channels, or recognized MIDI destinations for independent pairing with specific instrument or MIDI tracks, to enhance collaboration and interoperability.

In an embodiment, the system further includes a means to route the MIDI data stream originated from any individual creation area to independently pair with an individual instrument or MIDI tracks in a DAW running locally, or independently pair with individual tracks of connected external MIDI-capable devices for simultaneous playback.

In an embodiment, the system is operable to multitask with a DAW running on the same device, so to as provide the ability to route the MIDI data stream generated by chord selection, virtual instrument note playing, or Arpeggio running to independently paired virtual instrument tracks of a DAW or to connected external MIDI enabled playing devices. In an embodiment, the routing mechanism is operable to enable a MIDI data stream to be individually routed through the selection of a chord in the chord selection matrix, the selection of notes in the virtual instrument areas or within the MIDI stream generated by an arpeggio running in individual Arpeggiator panes, to independently paired instrument or MIDI track of a DAW. In this embodiment, the method simulates multiple external MIDI keyboards, multiple external MIDI sequencers and multiple external MIDI drum machines, playing individual instrument or MIDI tracks of a DAW.

In an embodiment, the system is operable to run on a tablet, smartphone, or other mobile device, communicating with one or multiple devices running a DAW, and providing the facility to route MIDI data streams from each creation area to independently paired individual instrument or MIDI tracks of the DAWs running on these devices, to enable multiple users to collaborate in real-time.

In this embodiment, the system includes a sync to downbeat means, operable to ensure that chord changes which are initiated by a user in the chord selection matrix are applied in synchronisation with the occurrence of a downbeat, which is the first beat in a bar, or on any beat occurrence, and in turn this synchronisation of chord changes to the downbeat enables patterns and/or sequences applied to individual notes configured and applied in the individual arpeggiator areas to be maintained in a correct play order when chord changes occur. In this embodiment sync to downbeat means also ensures that all chord changes applied in the chord selection matrix stay on the beat.

In this embodiment, the system further includes a visual metronome window operable to accommodate a time signature selection, a bar and beat position indicator, displaying a scrolling cursor identifying the current play position of a beat within a specific bar and within a section of a composition.

In an embodiment, the system includes a visual metronome display area which provides synchronization options for chord changes, arpeggio patterns, or instrument activations with a selected beat, enhancing rhythmic precision within a music composition.

In this embodiment, the visual metronome display area enables chord changes applied in the chord selection matrix to be synchronized with the onset of a downbeat, or with any beat occurrence, to ensure patterns and sequences applied to individual notes in arpeggiator areas remain in sync during chord changes.

In an embodiment of the invention, the system includes a user experience (UX) interface, operable to enable assistance of users, at all levels of music experience, to create complex music compositions, almost instantaneously, whilst they absorb the music concepts essential to longer-term composition and creation success. In this embodiment, the user experience (UX) interface assists users to independently play any virtual instrument or MIDI track in a DAW.

A computer-implemented method for music composition and performance, including one or more of the following steps:
displaying a chord selection matrix template associated with a musical key or a key combination;
assigning one or more notes, associated with a chord element selected from the chord selection matrix, to activate one or more control functions or activation control members of a virtual instrument;
playing one or more audio sounds of a digital musical file, associated with an individual note assigned to the selected chord element;
displaying an arpeggiator area with a master control pane and multiple individual arpeggio panes associated with the selected digital musical file;
assigning notes associated with the selected chord element to arpeggio panes and arranging them in patterns and sequences for playback;
displaying an arpeggio configuration window and a notes configuration window for interactive and real-time modification of arpeggio and note patterns during music composition and performance; and
providing a versatile MIDI destination configuration, enabling the selection of virtual MIDI ports, MIDI channels, or recognized MIDI destinations for independent pairing with a specific instrument or MIDI track.

In an embodiment, the method includes one or more of the following steps:
displaying a visual metronome area for synchronization options of chord changes, arpeggio patterns, or instrument activations with a selected beat;
synchronizing chord changes with a downbeat or any beat occurrence to ensure patterns and sequences in arpeggiator areas remain in sync during chord changes;
providing a prime function to arm the metronome to play on the first chord selection in the chord selection matrix;
recording, displaying, and playing chord progressions developed through the selection of chord elements in the chord selection matrix; and
displaying a MIDI destination routing configuration area to show available MIDI playing destinations, devices, on-board virtual instrument destinations, and associated controls, settings, and adjustments.

One embodiment, as an example of this invention discloses a set of instructions for a computer software application to perform the method described herein. In this embodiment, the software application may be operable to be executed on a mobile device such as a tablet or a smart phone. In this embodiment, the software application is operable to enable communication with one or multiple other mobile devices, such as tablets or smartphones running a DAW, or to any MIDI capable playing device, where the application provides the facility to route the MIDI data streams generated at each of the creation areas of the application, to independently paired individual instrument or MIDI tracks of the individual DAWs running on these devices, to play the musical sounds associated with the individual tracks of the DAW. This feature allows interactive multi-user collaboration, in real-time.

A computer system for facilitating music composition and performance, including one or more of the following:
a screen display device;
one or more data processors;
one or more non-transitory computer-readable storage media containing instructions for a computer software application to perform one or more of the following tasks:
displaying a chord selection matrix template on a first region of the screen device, associated with a musical key or key combination,
assigning notes associated with the selected chord element to activation control members of the virtual instrument,
playing audio sounds associated with the selected chord element,
displaying an arpeggiator area with a master control pane and multiple individual arpeggio panes associated with a selected digital musical file,
assigning notes associated with the selected chord element to arpeggio panes for arrangement in patterns and sequences,
displaying an arpeggio configuration window and a notes configuration window for interactive and real-time modification of arpeggio and note patterns,
providing a versatile MIDI destination configuration for independent pairing with specific instrument or MIDI tracks in a DAW or external MIDI-capable device.

In an embodiment, the non-transitory computer-readable storage media contains instructions for a computer software application to perform one or more of the following tasks:
displaying a visual metronome area for synchronization options of chord changes, arpeggio patterns, or instrument activations with a selected beat, the metronome area including a prime function to arm the metronome to enable play on the first chord selection in the chord selection matrix, the metronome area being operable to record, display, and play chord progressions developed through the selection of chord elements,
displaying a visual metronome window with sync to a beat such as a downbeat, or free run selection,
displaying a MIDI destination routing configuration area to show available MIDI playing destinations, devices, on-board virtual instrument destinations, and associated controls, settings, and adjustments, and
displaying multiple advanced arpeggiator areas, chord selection matrix areas, virtual instrument playing areas, and a MIDI destination routing configuration area.

According to embodiments of the present invention, the software application is operable to provide a user interface on a selectable tab. In this embodiment, multiple tabs may be accommodated on the user interface and a user may be able to toggle between them.

In an embodiment of the invention, the step of assigning notes associated with the selected chord elements to activation control members of the virtual instrument, includes playing the audio sounds of the individual notes at an amplitude that corresponds to the position within the activation area where the user activated one or more virtual piano keys or one or more virtual strings of a virtual guitar. In this embodiment, the notes assigned to each string in the chord file are assigned as standard MIDI numbers.

According to embodiments of the present invention, the step of assigning notes associated with the selected chord element to arpeggio panes for arrangement in patterns and sequences includes exposing the notes associated with the selection of a chord element in the chord selection matrix to the software component administering the arpeggiation function.

According to embodiments of the present invention, the software application is operable to provide an option to synchronise chord element selection changes applied in the chord selection matrix, upon the occurrence of a beat such as a downbeat.

According to embodiments of the present invention, the software application is operable to display a visual metronome to allow for one or more of the following: synchronisation of chord changes, arpeggio pattern reset, and/or chord pattern changes upon the occurrence of a selected beat. In this embodiment, the visual metronome is operable to identify the first beat, the downbeat, at the start of each bar and a beat onset is represented by a scrolling identifier displayed within numbered bars. In this embodiment, visual metronome is operable to have synchronisation engaged when a chord selection changes. In this embodiment, when a chord selection changes the notes playing in an arpeggiator pane will also change to reflect the new chord note assignment, and their play pattern will also be reset so that the arpeggio play patterns remain synchronised with each other when chord selection changes occur. In an embodiment, the visual metronome is operable to continuously run and display one or more beat markers in real-time. In an alternative embodiment, the visual metronome is operable to stop running when a prime option is activated. In this embodiment, the prime option is operable to arm the metronome to start when the first chord element selection is made in the chord selection matrix. This ensures that chords and arpeggiators start playing together, immediately, in sync with the first downbeat of the first bar.

According to embodiments of the present invention, the software application is operable to display a chord progression timeline area associated with the visual metronome window that provides a means to record, display and play chord progressions that were created by capturing the chord element selections that were manually selected in the chord selection matrix.

According to embodiments of the present invention, the software application is operable to to present the captured chord element selections from the chord selection matrix, on a timeline, that intuitively advises its corresponding position within a chord selection matrix.

According to embodiments of the present invention, the software application is operable to provide a means to autoplay the captured chord progression timeline in a manner that simulates manual selection of a chord element within a chord selection matrix.

According to embodiments of the present invention, the software application is operable to provide a means to save and recall a chord progression timeline.

According to embodiments of the present invention, the software application is operable to display an arpeggiator area which includes a master control pane and one or more individual arpeggiator panes. In this embodiment, the master control pane includes one or more controls and/or settings which are associated with the individual arpeggiator.

According to embodiments of the present invention, the software application is operable to enable interactive and real-time user intervention with all arpeggios running in their individual panes to enable the manipulation, adjustment and control of the assigned settings, selections, and controls for the individual chord notes during an arpeggiation playing cycle.

In this embodiment, real-time intervention in the arpeggiator panes allows adjustments and changes to individual settings, for example: note order, note value (steps), note lengths (gate), direction of movement, octave ranges, note interval settings, play sequence, lock/unlock, transpose chord, transposition steps, transition pattern and direction, piano or guitar chord voicing, solo, mute, volume, and the like.

According to embodiments of the present invention, the software application is operable to provide a means to save and recall a displayed arpeggiator pane, with its controls, selections and settings and associated configuration windows.

According to embodiments of the present invention, the software application is operable to provide a means to save and recall a user interface configuration for any tab, which include the selected musical key, the virtual instrument selection, the metronome settings, the arpeggio panes with their individual controls, selections and associated configuration windows.

According to embodiments of the present invention, the software application is operable to show a playing indicator on a background tab. In this embodiment, the playing indicator is operable to immediately alerts the user that an earlier tab is still playing sounds across the currently opened tab.

According to embodiments of the present invention, the software application includes a user interface display including all the current creation tabs, together, in a tile layout. In this embodiment, the tile layout is operable to be moved between tiles and operable to make selections and adjustments, in the individual displayed tabs, interactively and in real-time.

According to embodiments of the present invention, when the chord name is selected within an arpeggiator pane, a dropdown window is presented to facilitate further configuration and adjustment of the individual chord notes into advanced note patterns and sequences for the arpeggio, where an individual note within an arpeggio patterns has its own assigned settings and controls, which can be modified and adjusted interactively and in real-time for example: note active/inactive, note lengths (gate), note value, note interval setting, note volume, note mute and note solo, to name a few.

According to embodiments of the present invention, the software application includes a further, more advanced level of note configuration for an arpeggio. In this embodiment, the more advanced level of configuration facilitates the creation of rhythmic patterns and sequences to the individual notes of an arpeggio, interactively and in real-time. Here, rhythmic patterns and sequences can be created and adjusted, interactively and in real-time by changing and adjusting, amongst others; note order, note value (steps), note lengths (gate), note volume, note mute, note solo, note active/inactive, and the like.

In an embodiment, each arpeggio pane allows interactive and real-time toggling between piano and guitar chord voicing. In this embodiment, a play pattern indicator is displayed that follows the arpeggio pattern playing in the arpeggio pane.

In an embodiment of the invention, the software application includes a transposition means, which is operable to enable each of the one or more arpeggio panes to support an arpeggio transposition. In this embodiment, the transposition means is operable to transpose an arpeggio, as it is configured, in terms of a selected interval in patterns and/or sequences. In this embodiment, the transposition means that is configured in an individual arpeggiator pane may transpose an arpeggio pattern by a selected interval value, over multiple steps, in different patterns, cycles or sequences.

According to embodiments of the present invention, the transposition means is operable to transpose an arpeggio by any of up to twelve interval values, over many steps, in different patterns, cycles and sequences, when transposition is selected. In this embodiment, the transposition means includes arpeggio transposition settings, and/or controls which can be changed and adjusted, interactively and in real-time. In this embodiment, the transposition means includes a transposition option which contains arpeggio transpositions to the eight interval values of the scale of the selected key. In this embodiment, upon selection of the transposition option the transposition means is operable to enable a simulation of playing virtuosity with any instrument sound and is operable to add flair, flow, colour, variety and depth to soloing. It is to be appreciated that the transposition means is operable to allow very efficient, original beat creations. As the MIDI note assignment table for drum and percussion sounds contains the note assignments within a very narrow octave range, transposing by one, or a few semitones, in cycles and patterns, will produce stunning beat patterns.

According to embodiments of the present invention, the transposition means is operable to provide real-time and interactive transpositions, with different interval settings to provide additional texture, tension, flow, movement and variety to arpeggios, as some notes, when transposed by different intervals, will fall outside the selected key. In this embodiment, the transposition means is operable to introduce interval changes interactively and in real time, and flow seamlessly into an arpeggio.

According to embodiments of the present invention, the system includes a play-through means which is operable to play one or more notes assigned to a selected chord element, together with the arpeggio notes playing. In this embodiment, the play-through means is operable to be enabled and/or disabled interactively and in real-time.

According to embodiments of the present invention, the system includes a locking means which is operable to lock a selected chord to an arpeggiator pane until it is unlocked. In this embodiment, the locking means may be enabled and/or disabled interactively and in real-time. In this embodiment the locking means is central to the development of a strong and engaging beat, with a strong rhythmic component, when percussion instrument sounds are used that are assigned to specific musical notes, the notes corresponding to the MIDI note assignment table for drum and percussion sounds.

### BRIEF DESCRIPTION OF THE DRAWINGS

Certain preferred embodiments of the present invention will now be described, by way of example only, with reference to the accompanying drawings in which:

FIG. 1 is a user interface of a system for facilitating music composition and performance, in accordance with prior art developed by the same inventor;

FIG. 2 is a user interface of a system for facilitating music composition and performance, in accordance with prior art developed by the same inventor and in accordance with an embodiment of the invention;

FIG. 3 is a user interface of a system for facilitating music composition and performance, in accordance with an embodiment of the invention;

FIG. 4 is a user interface of a system for facilitating music composition and performance, in accordance with an embodiment of the invention;

FIG. 5 is a user interface of a system for facilitating music composition and performance, in accordance with an embodiment of the invention;

FIG. 6 is a user interface of a system for facilitating music composition and performance, in accordance with an embodiment of the invention;

FIG. 7 is a user interface of a system for facilitating music composition and performance, in accordance with an embodiment of the invention;

FIG. 8 is a user interface of a system for facilitating music composition and performance, in accordance with an embodiment of the invention;

FIG. 9 is a user interface of a system for facilitating music composition and performance, in accordance with an embodiment of the invention;

FIG. 10 is a user interface of a system for facilitating music composition and performance, in accordance with an embodiment of the invention;

FIG. 11 is a user interface of a system for facilitating music composition and performance, in accordance with an embodiment of the invention;

FIG. 12 is a user interface of a system for facilitating music composition and performance, in accordance with an embodiment of the invention;

FIG. 13 is a user interface of a system for facilitating music composition and performance, in accordance with an embodiment of the invention;

FIG. 14 is a user interface of a system for facilitating music composition and performance, in accordance with an embodiment of the invention;

FIG. 15 is a user interface of a system for facilitating music composition and performance, in accordance with an embodiment of the invention;

FIG. 16 is a user interface of a system for facilitating music composition and performance, in accordance with an embodiment of the invention;

FIG. 17 is a user interface of a system for facilitating music composition and performance, in accordance with an embodiment of the invention;

FIG. 18 is a user interface of a system for facilitating music composition and performance, in accordance with an embodiment of the invention;

FIG. 19 is a user interface of a system for facilitating music composition and performance, in accordance with an embodiment of the invention;

FIG. 20 is a user interface of a system for facilitating music composition and performance, in accordance with an embodiment of the invention;

FIG. 21 is a user interface of a system for facilitating music composition and performance, in accordance with an embodiment of the invention;

FIG. 22 is a user interface of a system for facilitating music composition and performance, in accordance with an embodiment of the invention;

FIG. 23 is a user interface of a system for facilitating music composition and performance, in accordance with an embodiment of the invention; and

FIG. 24 shows a computer within which a set of instructions is set out for causing the computer to perform any one or more of the methodologies in accordance with aspects of the invention.

### DETAILED DESCRIPTION

In general, the present specification describes a system for and method of facilitating music composition and performance. Various embodiments of the present invention will be described in detail with reference to the drawings, where like reference numerals represent like parts and assemblies throughout the several views.

It will be appreciated that the invention should not be construed to be limited to the examples, which are now described; rather, the invention is construed to include any and all applications provided herein and all equivalent variations within the skill of the ordinary artisan. Indeed, the description which follows, and the embodiments of described therein, are provided by way of illustration of examples of embodiments of the principles of the present invention. These examples are provided for the purposes of explanation and not limitation of those principles and of the invention.

Furthermore, the following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptions to the present invention are possible and can even be desirable in certain circumstances and are a part of the present invention. Thus, the following description is provided as illustrative of the principles of the present invention and limitation thereof.

It is to be appreciated that all images disclosed can be resized using standard resizing methodologies.

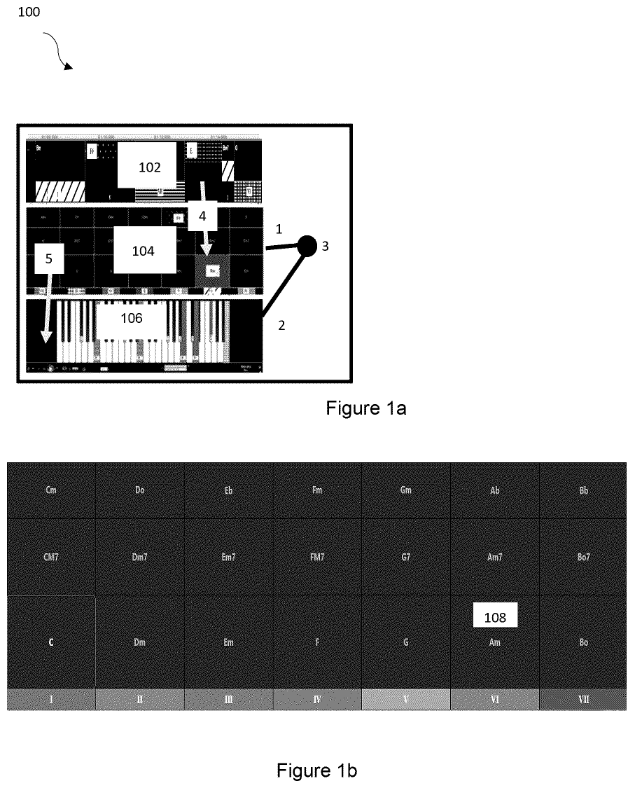

Referring to FIG. 1 of the drawings, there is shown a user interface of a system for facilitating music composition and performance according to prior art developed by the same inventor, generally referred to herein by reference numeral 100.

In FIG. 1a, the system 100 shows a user interface of a prior art system which includes a chord sector timeline 102 associated with a chord analysis file, a chord selection matrix 104 and a virtual instrument display 106 which together deliver a single MIDI output stream 3 from the combination of the MIDI outputs from label positions 1 and 3 which is routed to a single destination. The timeline MIDI output is associated with the chord selection matrix 104.

In FIG. 1b, the system 100 further includes a chord selection matrix area 108.

The prior art describes a method and means, where, for every musical key/mode or combination key/mode, an associated chord selection matrix template has been developed where each chord (represented as an element of the matrix template) has a chord assignment file associated with that element. The chord assignment file contains the note assignment names, the notes assigned to the individual activation control member for different embodiments, and the MIDI note identifier number for each note assigned to an activation control member. The chord assignment file is editable by the user. When the user selects an element, the software application will assign the note name and MIDI number from the associated chord assignment file to the individual activation control members in the exact order that they are defined in the chord assignment file. When the user activates any of the activation control members associated with a selected element, the audio sounds of the individual notes assigned to each activation control member will be played by a selected MIDI enabled playing device.

According to embodiments of the prior art, chord selection matrix templates, with their individual elements are configured for a multiplicity of key/modes. For a selected musical key, a chord selection matrix will display triad chords on the bottom row. Seventh chords in the middle row, with borrowed chords displayed on the top row. Or alternatively, display a selectable range of advanced chord options. The addition of a fourth or more rows would allow the display of the seventh chords for combination key/modes or other more advanced chords.

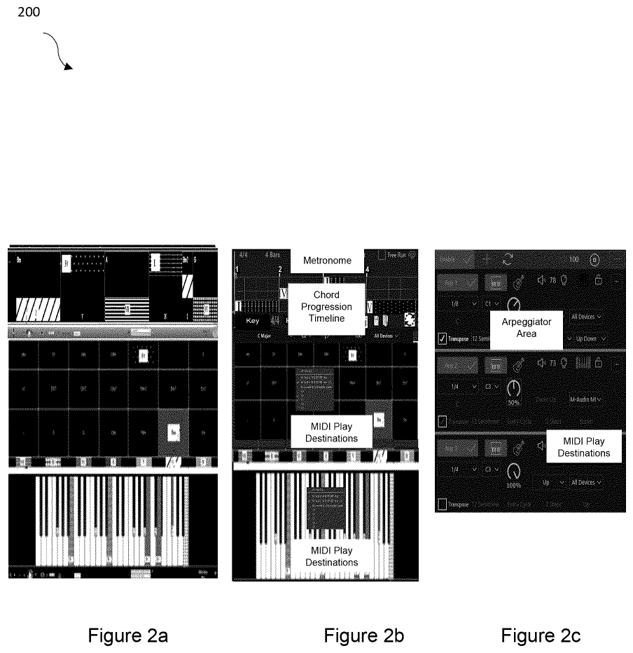

With reference to FIG. 2, there is shown a user interface of a system for facilitating music composition and performance according to prior art developed by the inventor and embodiments to the invention, generally referred to herein by reference numeral 200.

In FIG. 2a, the system 200 shows a user interface and associated components according to the prior art by the same inventor showing a chord selection matrix area, a chord timeline area associated with a chord analysis file generated from a music composition and a virtual instrument playing area.

In FIG. 2b, the system 200 shows a new user interface being an improvement on the prior art previously developed by the same inventor. The new user interface includes the addition of a visual metronome with chord change syncing, a chord progression timeline that captures, displays and plays the chord progressions generated by the selection of chords in the chord selection matrix as well as a MIDI routing menu to route the MIDI data generated from chord selection and virtual instrument playing.

In FIG. 2c, the system 200 further shows a chord selection matrix and a virtual instrument area, as per the prior art by the same inventor, showing the addition of MIDI play destination routing selections, a visual Metronome area, a chord progression timeline area associated with the capture of selected chord elements in the chord selection matrix.

The system 200 further shows an example of an arpeggiator user interface area and associated components according to embodiments of the present invention displaying a control area and multiple individual arpeggiator panes and showing a MIDI play destination routing selection area associated with each arpeggiator pane.

The new user interface is an improvement on the prior art by the same inventor and includes the addition of multiple arpeggiator areas to allow the configuration of note patterns and sequences to the notes of a selected chord to be played as individual arpeggios whilst also allowing interactive, real-time adjustment of all arpeggiator settings, controls and adjustments. Within this context, the MIDI data stream from individual Arpeggiator areas can routed to specific destinations.

In accordance with embodiments of the invention, one or more sets of instructions and data structures embodying or utilizing any one or more of the methodologies or functions described herein may be provided in the example form of a software application. With reference to the accompanying drawings, a computer is shown within which a set of instructions may be executed for causing the computer to perform any one or more of the methodologies described herein. In these embodiments, these instructions are executed within the context of the software application.

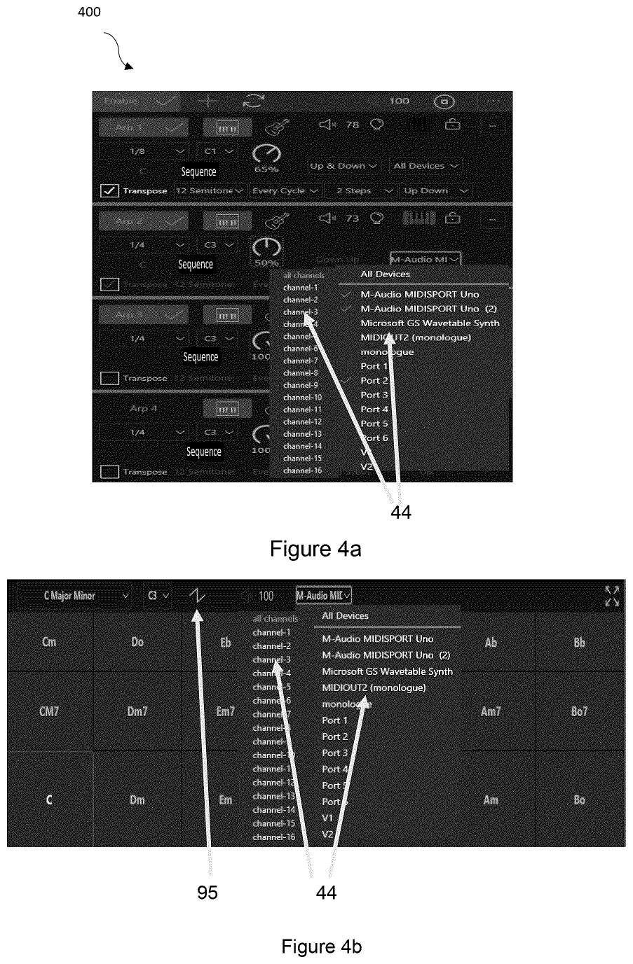

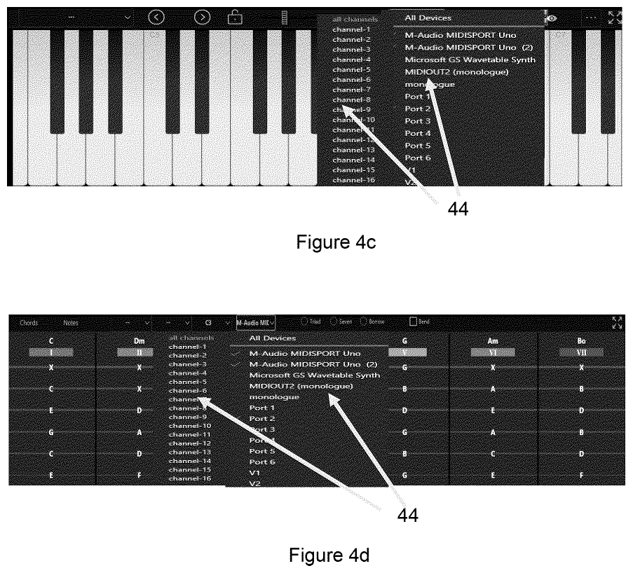

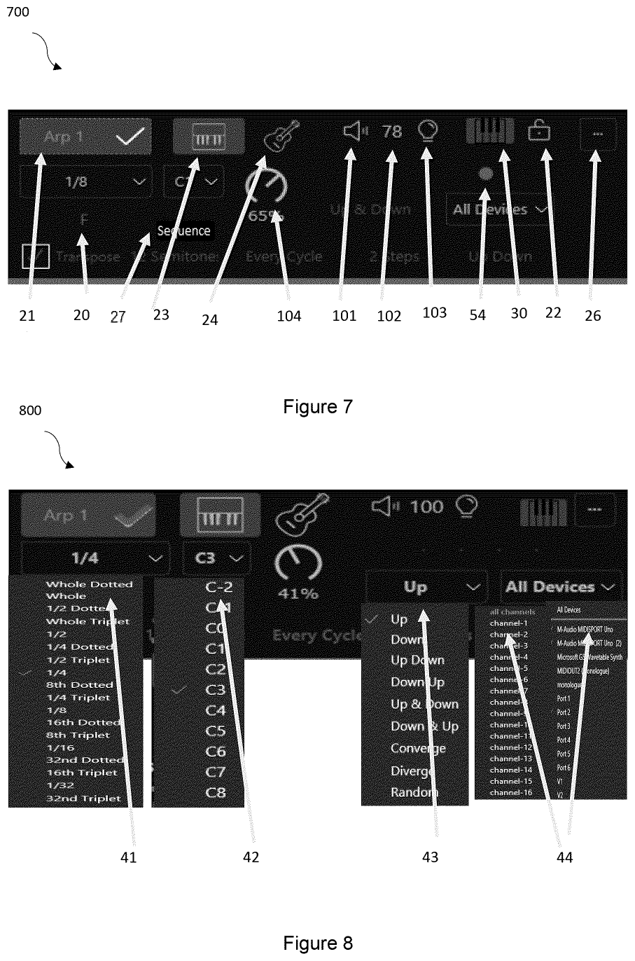

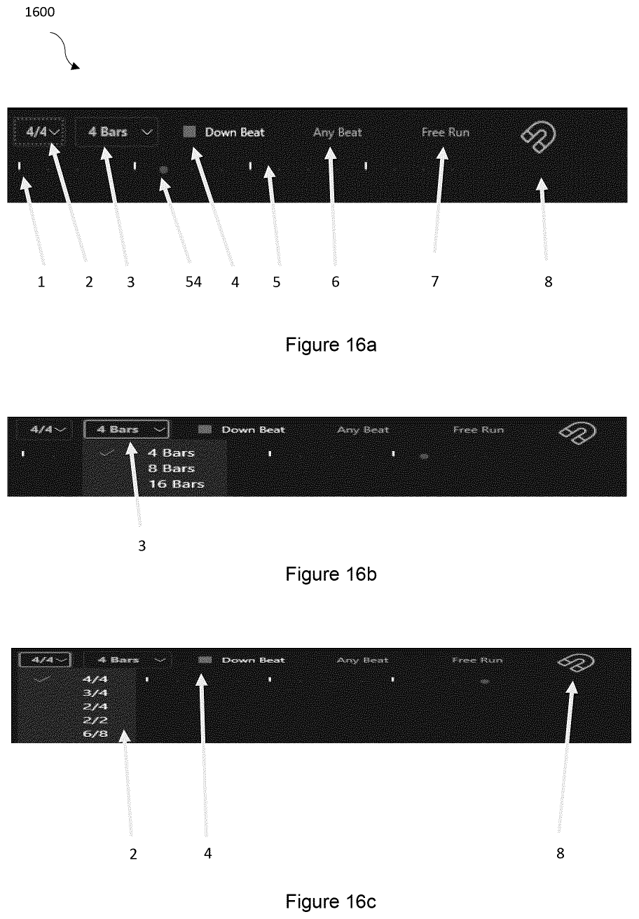

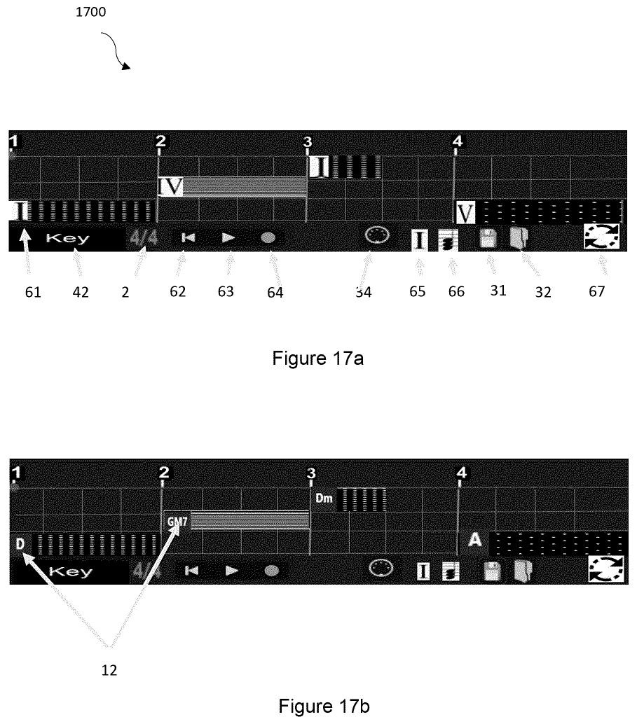

According to embodiments of the present invention, the software application will construct, as an example of a user interface and associated components, a chord selection matrix area as shown in FIG. 4b; based on the selection of one key or key combination as shown in FIG. 15 label 72; a virtual instrument playing area as shown in FIGS. 4c and 4d; a visual metronome area as shown in FIG. 16 a, b and c; a chord progression timeline area as shown in FIG. 17 a and b an arpeggiator user interface area and associated components according to FIG. 4a, FIGS. 6 and 7, in accordance with embodiments of the present invention.

According to embodiments of the present invention, when the user selects an element in the chord selection matrix template, as per FIG. 1a, the software application will assign the MIDI note number from the associated chord assignment file to the individual activation control members, as per FIGS. 4c and 4d and assign the chord note MIDI numbers to the software application component controlling the arpeggiator area, as per FIG. 4a, in the exact order that they are defined in the chord assignment file.

The most effective means to enable the independent routing and pairing of the MIDI data stream generated in each creation area of the application with specific instrument or MIDI tracks in a DAW is to communicate between the application and the DAW using virtual loopback MIDI ports. Virtual loopback MIDI is a virtual device that allows MIDI communications between applications running on the same device.

The MIDI protocol allows individual MIDI ports to have multiple independent MIDI communications channels. For some devices, especially some mobile devices, only a single MIDI port is available for inter application communication using MIDI. In these cases, independent pairing between the independent application creation areas and independent instrument tracks of a DAW, is achieved using different MIDI channel assignments.

In a Windows™ environment, virtual loopback MIDI ports can be quick and easily created using of the shelf applications. For Windows™ devices. The most popular virtual loopback MIDI port creator is loopmidi. Apple™ provides an iac (inter application communication) virtual loopback MIDI port creation utility for their Mac™ based DAW.

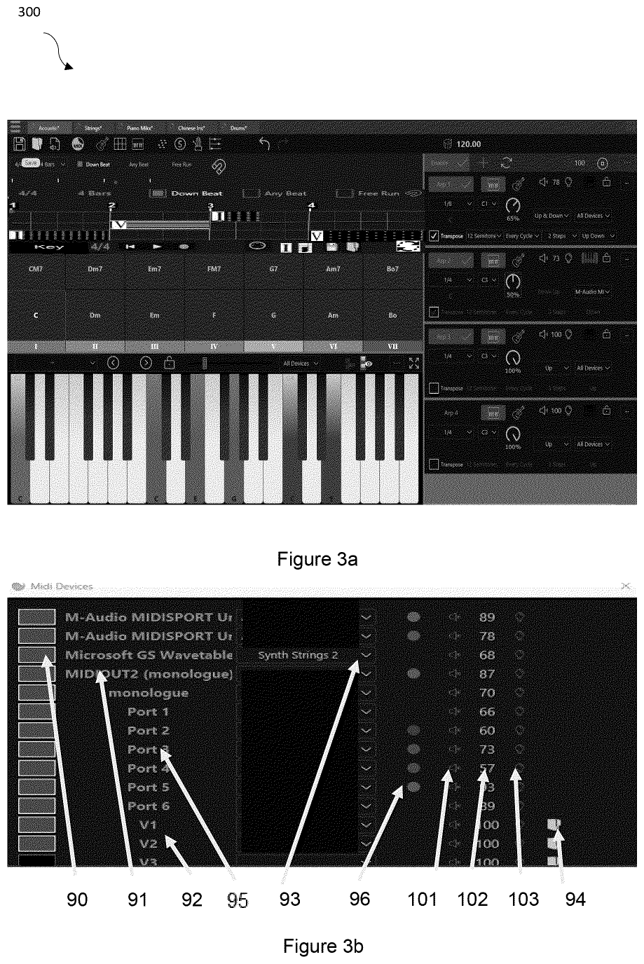

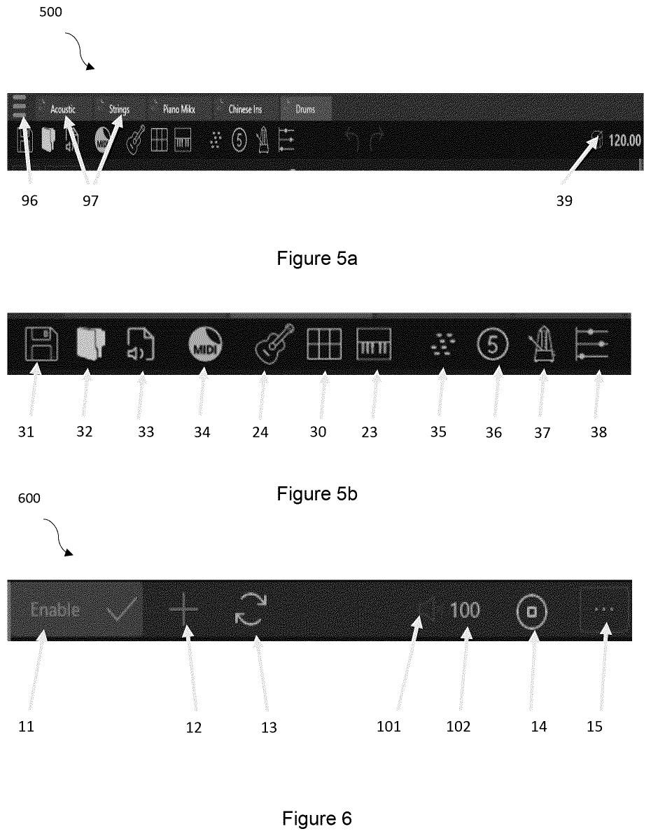

According to embodiments of the present invention, the software application provides the facility to route the MIDI data stream generated in individual creation areas, by assigning individual MIDI ports and channels to the individual creation area, which can be independently paired with instrument or MIDI tracks of a DAW, with any MIDI capable playing device, with a synthesiser, or with any internal or external MIDI capable playing device. When a MIDI device destination 34, as per FIG. 5b, is selected, a floating window, as per FIG. 3b, is presented, showing a MIDI play destination routing configuration area, displaying the available virtual loopback MIDI ports 95 The virtual instrument channels 92, and other MIDI-capable devices that are recognised and available to be selected 91, with their associated selections, controls, adjustments and settings are displayed according to embodiments of the present invention.

According to an embodiment of the present invention, a software application is disclosed that is running on a tablet, smartphone or other mobile device, which is communicating with one or multiple other tablets, smartphones or other mobile devices running a DAW, where the application provides the facility to route the MIDI data stream generated at each of the creation areas to independently pair with individual instrument or MIDI tracks of the individual DAWs, to play the musical sounds associated with the individual tracks of the DAW. This feature allows for multiple user collaboration, interactively and in real-time. This feature simulates multiple external MIDI keyboard, multiple external MIDI sequencers and multiple external MIDI drum pads playing simultaneously on an individual instrument or MIDI tracks, of multiple individual DAWs, running simultaneously, on one or multiple tablets, smartphones or other mobile devices.

According to an embodiment of the present invention, there is disclosed a software application running on an iPad™, iPhone™, Android™ smart phone, Android™ tablet, smart phone or other mobile computing devices communicating with one, or multiple iPads™, iPhones™, Android™ smartphones, Android™ tablets, smartphones or other mobile computing devices running a DAW, such as Garageband™, Cubasis™ or any DAW, where the application provides the facility to route the MIDI data stream generated at each of the individual creation areas of the application to independently pair with individual instrument or MIDI tracks of the individual DAWs running on a connected devices to play the musical sounds associated with individual tracks of the DAW. A user interacting on individually connected devices can control, change, adjust parameters and settings associated with individual tracks of the DAW interactively and in real-time. The facility to route individual MIDI data streams from individual creation areas within the application to be paired with individual instrument tracks of individual destinations provides a true music creation collaboration platform for creators and performers at all levels of music theory knowledge and playing experience.

With reference to FIG. 3, there is shown a user interface of a system for facilitating music composition and performance according to embodiments of the invention, generally referred to herein by reference numeral 300.

In FIG. 3a, the user interface 300 shows a chord selection matrix area, a virtual instrument area, a visual metronome area, a chord progression timeline area, an arpeggiator user interface area and associated components according to embodiments of the present invention.

In FIG. 3b, the user interface 300 further shows a master MIDI play destination routing configuration area, showing associated selections, controls, adjustments and settings according to embodiments of the present invention.

FIG. 3 shows an example of a user interface and associated components according to embodiments of the present invention, including a MIDI destination master control area that will display all available MIDI destinations detected by the software application that allows users to select destinations and to set and adjust parameters associated with the MIDI data transmission to individual play destinations, for example: the available virtual loopback MIDI ports 95, all externally recognised MIDI playing destinations 91, all on-board virtual instrument selections 92, an instrument sound selection for an external device, if supported, 93, enable/disable a destination 90, an indicator showing MIDI transmission activity to a destination 96, mute MIDI to destination 101, volume adjustment to destination 102, solo to destination 103, sound font instrument selection 94, to name a few. On-board virtual instrument MIDI destinations may be provided 92. For example, the SoundFont™ virtual instruments are displayed as v1, v2, etc. 92. Selection 94, displays the SoundFont™ instrument libraries, where instrument selections can be made, which can be assigned to one, multiple, or all the on-board virtual instrument destinations.

With reference to FIG. 4, there is shown a user interface of a system for facilitating music composition and performance according to embodiments of the invention, generally referred to herein by reference numeral 400.

At FIG. 4a, the system 400 shows an arpeggiator user interface area and associated components according to embodiments of the present invention, displaying a master control area and multiple individual arpeggiator panes and showing a MIDI play destination routing selection area according to embodiments of the present invention.

At FIG. 4b, FIG. 4c and FIG. 4d, the system 400 further shows MIDI play destination routing selection areas according to embodiments of the present invention.

According to embodiments of the present invention, the software application provides the facility to route the MIDI data stream from a chord element selection 44, as per FIG. 4b, a virtual instrument play area, as per FIG. 4c and FIGS. 4d, 44, or an individual arpeggiator, as per FIGS. 4a, 44, to individual destinations in the MIDI destination master control area, as per FIG. 3b. Dropdown menus 44, appear for each of the creation areas FIG. 4, a, b, c and d that display the MIDI play destinations available for selection showing ports with individual channel assignment selection for each port.

With reference to FIG. 5, there is shown a user interface of a system for facilitating music composition and performance according to embodiments of the invention, generally referred to herein by reference numeral 500.

In FIGS. 5a, 39, the system 500 shows an example of a main menu bar showing tempo selection according to embodiments of the present invention.

According to embodiments of the present invention the software application will display a tab 97, as per FIG. 5a, and construct a virtual instrument play area, as per FIG. 4c and FIG. 4d, an arpeggiator user interface area and associated components as per FIG. 4a, FIG. 6 and FIG. 7. For an example of a user interface and associated components, refer to FIG. 3a, which shows a chord selection matrix area as per FIG. 4b, which is based on the selection of a key or a key combination 72, as per FIG. 15. New user interface tabs can be created by selecting 33 as shown in FIG. 5 b. Multiple tabs can be created in terms of which a user can toggle between them quickly to improve workflow efficiency.

As shown in FIG. 5 a, with reference to numeral 39, tempo selection provides a means to set the rate at which beats occur in the metronome. For a user's compositions and performances selecting the tempo area and moving up or down, left or right, will change the tempo value setting. Alternatively, a numeric value can be entered in the tempo box. Tempo values can be fine-tuned using the arrow up/down, left/right keys.

According to embodiments of the present invention, the software application displays an arpeggiator user interface area, as shown in FIG. 4a. This interface can be used to facilitate the configuration of individual arpeggiators settings, adjustments, and controls to be applied to an arpeggio running in that pane. The software application enables interactive and real time intervention in the arpeggio playing cycle, to change, adjust, reset, and modify, settings, adjustments, and controls associated with an arpeggio playing in an arpeggiator pane, as shown in FIG. 7.

An arpeggio takes the individual notes of a chord and arranges them in patterns and sequences, where each note is played or rested, individually, in rhythmic patterns. Arpeggios create rhythmic interest. Developing the knowledge and skill required to play arpeggios, is a daunting task, and it can take many years to master the knowledge and develop the playing skills to achieve an acceptable level of performance virtuosity.

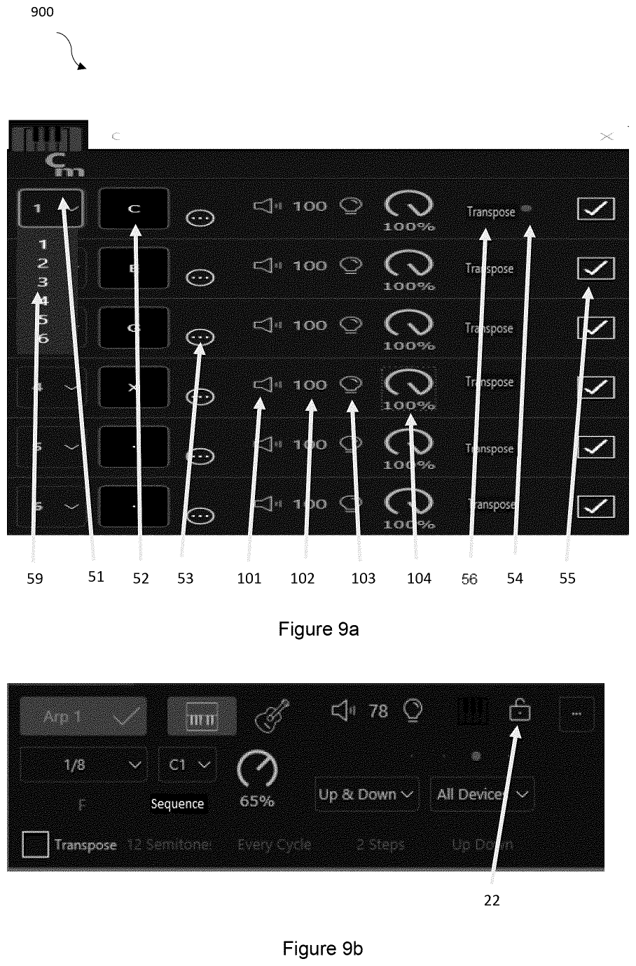

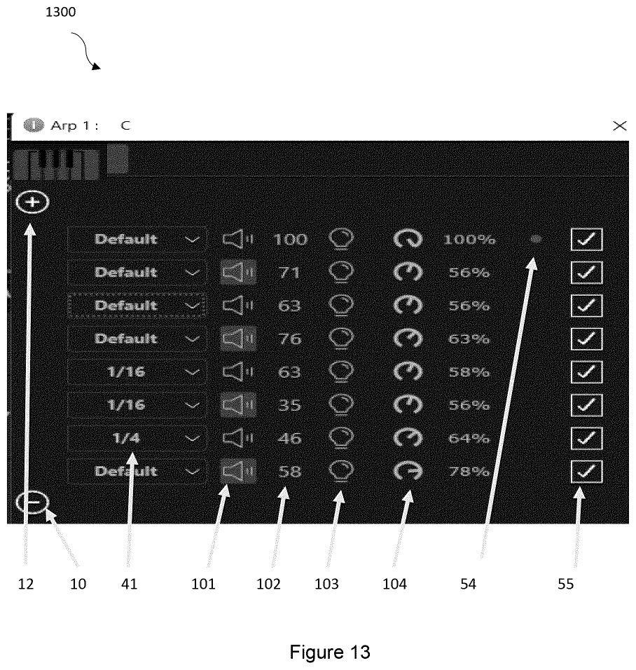

According to a further embodiment of the present invention, the software application provides the facility to configure a selected chord to play in patterns and sequences, as shown in FIG. 13. When 30 in FIG. 7 is selected, the software application will take the notes of the selected chord, as configured in FIG. 9a, and play them together, as configured in the user interface FIG. 13, in patterns and sequences, applying the associated control settings and adjustments when playing the notes associated with the chord.

When arpeggiation 35 is selected, as shown in FIG. 5b, a user interface is presented which displays an arpeggiator master control pane, as per FIG. 6, that is associated with the individual arpeggiator panes, as shown in FIG. 7.

In this embodiment, as an example only, FIG. 6 displays the following master settings for the arpeggiator areas: arpeggiator enable 11, which enables/disables all individual arpeggiator panes. As a default, a single arpeggiator pane is displayed. Arpeggiator panes can be added by selecting the + button, 12. The master volume associated with all arpeggiators can be adjusted, 102, or muted, 101. When the stop button, 14, is selected, all arpeggiators stop playing. All enabled arpeggiators will start playing when the next chord element is selected. An arpeggiator user interface, with its associated arpeggiator panes and their associated settings, controls, adjustments, together with their note pattern configuration settings and controls can be saved by selecting 15.

It is possible, that when many arpeggiators with complex settings are running concurrently, individual arpeggiator patterns and sequences may get out of sync with each other. If this unlikely event occurs, there is a facility to “reset all arpeggiators to the downbeat” 13, as shown in FIG. 6. All arpeggiators will then reset in sync together on the next downbeat. According to embodiments of the present invention providing the facility to lock 22 a selected chord to an arpeggiator pane is shown in FIG. 9b. In this regard, a facility is provided to lock a selected chord in the arpeggiator which will keep the assigned chord locked to that arpeggiator pane until it is unlocked. Lock can be enabled/disabled interactively and in real-time.

The chord lock facility in individual arpeggiator panes is integral to the develop of novel and memorable beats, with strong rhythmic components using drums and percussion instrument sounds that conform with the MIDI note assignment table. With just the chord root note activated, a user can develop a novel range of drum and percussion beat patterns and sequences with just a single arpeggio. With multiple arpeggiator panes locked to different chord selections, with their notes mapped to different drum and percussion instrument notes, a user can create compelling beat patterns with multiple percussion instruments playing simultaneously with all their beats in sync.

According to embodiments of the present invention, a play-through facility 95, as shown in FIG. 4b, is provided which allows the notes of a selected chord element to be played together with the arpeggios that are playing in the arpeggiators.

With reference to FIG. 6, there is shown a user interface of a system for facilitating music composition and performance according to embodiments of the invention, generally referred to herein by reference numeral 600.

Moreover, in FIG. 6, the system 600 shows example of an arpeggiator user interface, displaying a main control pane of the arpeggiator area and displaying associated components according to embodiments of the present invention.

With reference to FIG. 6, activating the enable button 11, enables/disables all individual arpeggiator panes. As a default, a single arpeggiator pane, as per FIG. 7, is displayed. Arpeggiator panes can be added by selecting the +button 12, as shown in FIG. 6.

With reference to FIG. 7, there is shown a user interface of a system for facilitating music composition and performance according to embodiments of the invention, generally referred to herein by reference numeral 700.

In FIG. 7, the system 700 shows an example of an arpeggiator user interface, displaying an individual arpeggiator pane of the arpeggiator area and displaying associated components according to embodiments of the present invention.

As per FIG. 6, in accordance with embodiments of the present invention, multiple arpeggiators can be played simultaneously. The software application supports interactive and real time interventions to change and adjust settings, controls, and adjustments. Multiple arpeggiator panes, as shown in FIG. 7, can be added by selecting the + button 12, shown in FIG. 6. An arpeggiator pane can be removed by selecting 26, as shown in FIG. 7.

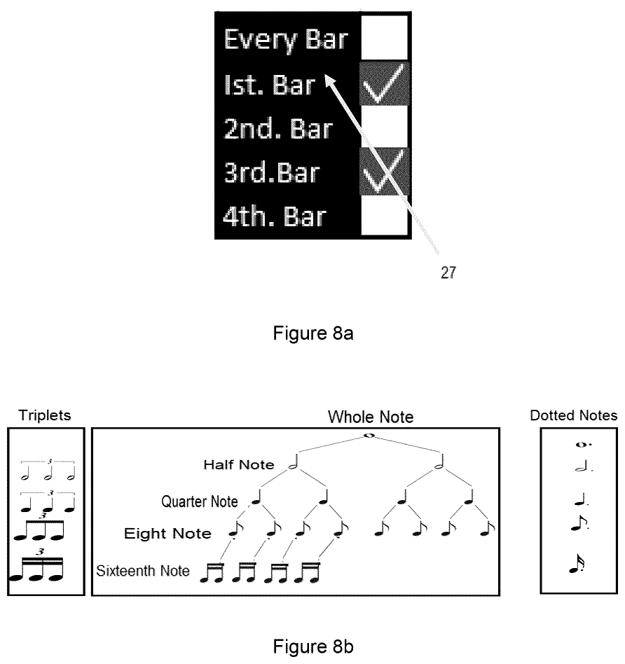

In FIG. 7, according to embodiments of the present invention, an example user interface is presented, where the software application facilitates the creation and playing of bespoke arpeggios that are rhythmically complex, almost immediately, with just a few parameter settings, as shown in FIG. 8.

With reference to FIG. 7, according to embodiments of the present invention the software application includes a user interface which represents a single arpeggiator area, including the following functions: enable/disable 21, select piano 23 or guitar 24, chord voicing, mute 101, volume 102, solo 103, gate 104, chord play 30, save arpeggiator settings 26, note activity play pattern visual indicator 54, lock chord 22 and note configuration selection 20. With reference to FIG. 8, there is shown a user interface of a system for facilitating music composition and performance according to embodiments of the invention, generally referred to herein by reference numeral 800.

In FIG. 8, the system 800 shows example of an arpeggiator user interface, showing settings, controls and adjustments together with dropdown selection menus associated with an arpeggio running in an arpeggiator pane and displaying associated components according to embodiments of the present invention.

In FIG. 8a, the system 800 includes an arpeggiator dropdown menu showing different bar play period selections for playing the configured arpeggio according to embodiments of the present invention.

In FIG. 8b, the system 800 includes an image representing musical note value relationships corresponding to note step values displayed in a dropdown menu, according to embodiments of the present invention.

In FIG. 8, according to embodiments of the present invention, dropdown selection menus associated with FIG. 7 are shown, including: showing note step selection 41, octave range selection 42, note pattern selection 43, MIDI play destination selection showing both port and channel selections 44.

With reference to FIG. 8a, according to the present invention, as example, when the sequence option 27 is selected, as shown in FIG. 7, a dropdown menu will be displayed. The arpeggio will only play in the selected bar/bars. The dropdown selection is not restricted to the option disclosed and the options can be expanded to any number of bars. This facility is very effective when creating complex beat patterns using arpeggios with transpositions. FIG. 8b shows note value relationships as associated with note steps 41. As per FIG. 8, a step can also reference a note silence, commonly called a rest. Note values are the cornerstone of arpeggiation. Varying note values and note lengths in arpeggiation sequences are a major contributor to great melodies and harmonies. The innovative arpeggiator features and functions disclosed in this invention allow interactive and real-time creation and development of endless note patterns, sequences, and movement to arpeggios to enhance creative and performance endeavours. A step does not necessarily fall on a beat. There are many different note values (steps) that can occur within a beat period. A note value (step) defines the proportion of a beat that separates the playing/resting of one note and the playing/resting of its following note. Separately and independently, a note can be held to be playing for any percentage of its total step value. In this disclosure, the play length of each note can be adjusted, interactively and in real time by varying the gate setting for individual note steps. A silence/rest is played by activating a step and muting it, or by turning its volume to zero. FIG. 8b shows the most popular note values (steps) in music. Note values are related proportionally to each other.

With reference to FIG. 9, there is shown a user interface of a system for facilitating music composition and performance according to embodiments of the invention, generally referred to herein by reference numeral 900.

In FIG. 9a, the system 900 shows example of an arpeggiator user interface displaying settings, controls and adjustments associated with an Arpeggiator pane together with associated components according to embodiments of the present invention to allow the configuration and adjustment of individual note settings and controls of an arpeggio according to embodiments of the present invention.

In FIG. 9b, the system 900 further shows an example of a chord lock facility to keep an assigned chord locked to that arpeggiator pane according to embodiments of the present invention.

With reference to FIG. 9a, according to embodiments of the present invention, an example user interface is presented to facilitate the further configuration of the individual notes of an arpeggio.

In FIG. 9a, according to embodiments of the present invention, a user selects a chord name in the arpeggio pane. As per FIG. 7, a note configuration user interface 20 is presented, as shown in FIG. 9a, to allow the configuration and adjustment of individual chord notes of a selected chord, to be played as an arpeggio. The numeric value 51, displayed on the left of each note of the selected chord advises the order that note is to be played in the arpeggio. The note play order can be changed from the dropdown menu 59. When a note is active, it will play in its note value order with the controls and settings assigned. Settings and controls for individual notes, include, as example: mute 101, volume 102, solo 103, gate 104, note activity indicator 54, note active selection 55 and note transpose 56. A rest/silence is played when a note is active and is muted, or has its volume set to zero.

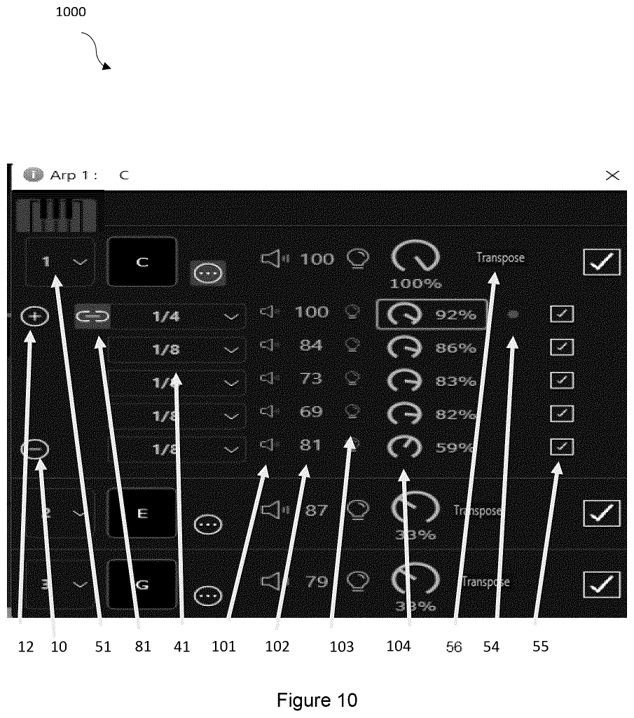

With reference to FIG. 10, there is shown a user interface of a system for facilitating music composition and performance according to embodiments of the invention, generally referred to herein by reference numeral 1000.

FIG. 10 shows example of an arpeggiator user interface section showing individual settings, controls and adjustments associated with individual notes of an arpeggio to generate complex and novel play patterns and sequences to each individual notes of an arpeggio running in that pane.

FIG. 10 according to embodiments of the present invention, an example user interface is presented, to allow the user to configure additional steps for each note of an arpeggio running in that pane to create rhythmic patterns and sequences for the individual notes of the arpeggio. FIG. 10 shows an example user interface to allow the addition of multiple customisable steps to each note of an arpeggio running in that pane. All patterns and sequences can be changed, adjusted and controlled, interactively and in real time for each note step.

In FIG. 10, according to embodiments of the present invention, selecting 53 on FIG. 9 a, an individual note configuration pane expands to display a user interface. As an example, as shown in FIG. 10, the interface provides the facility to add multiple additional steps to each note of an arpeggio to allow the user to configure advanced patterns and sequences to an arpeggio. Individual note values can be assigned to each additional note step from the dropdown menu 41, shown in FIG. 8. Notes will play as configured, with the controls and settings assigned for each active step. Settings and controls for individual notes, include, as example, mute, 101, volume, 102, solo, 103, gate 104, note active selection 54 and note transpose 56. A rest/silence is played when a note is active and is muted or has its volume set to zero.

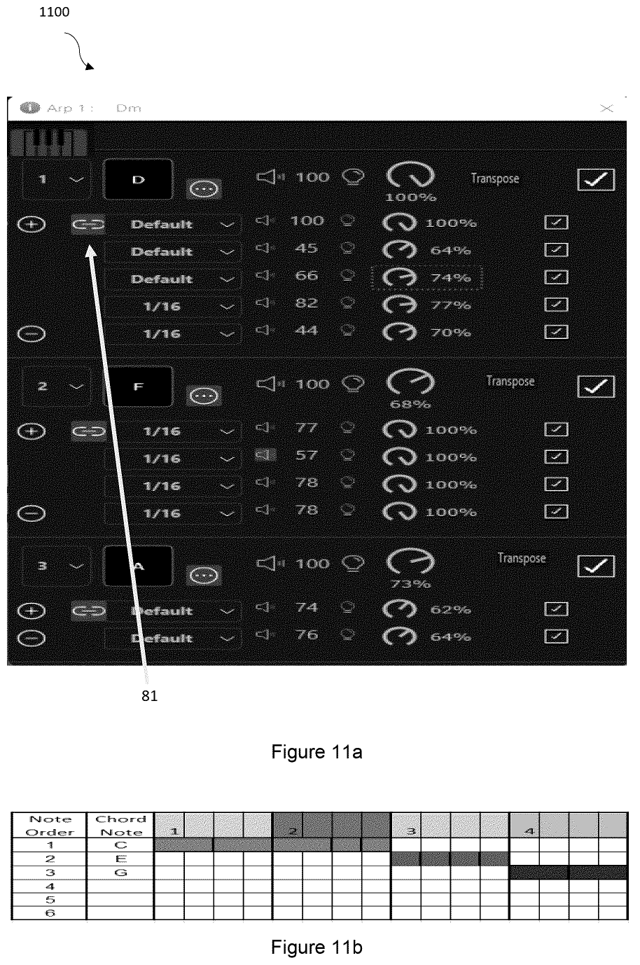

With reference to FIG. 11, there is shown a user interface of a system for facilitating music composition and performance according to embodiments of the invention, generally referred to herein by reference numeral 1100.

In FIG. 11a shows an example of a user interface showing chain or alternate mode selection in an arpeggiator.

In FIG. 11b, the system 1100 shows an example image of note patterns generated with chain or alternate mode selected in an arpeggio.

In FIG. 11a, according to embodiments of the present invention, an option is provided to facilitate the addition of a further layer of patterns and sequences to arpeggios within each pane by selecting chain or alternative mode label 81.

With chain mode 81 selected, the arpeggiator will play, in descending order, all the active note steps assigned to that note, before moving to the next higher order note position. A visual indicator 54, as shown in FIG. 10, is presented to identify the note step currently playing in the configured pattern.

In turn, FIG. 11b displays a table showing the note play pattern in the arpeggiator pane resulting from the chain mode configuration in FIG. 11a.

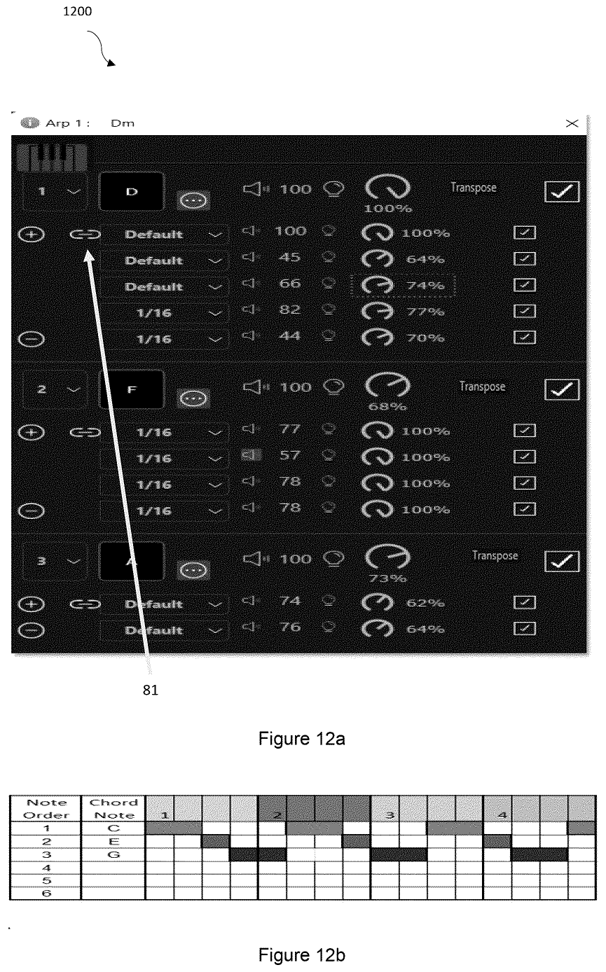

With reference to FIG. 12, there is shown a user interface of a system for facilitating music composition and performance according to embodiments of the invention, generally referred to herein by reference numeral 1200.

In FIG. 12a a user interface is displayed note order value that the arpeggiator will follow in playing the notes.

FIG. 12b displays a table showing the note play pattern resulting from the alternate mode configuration in FIG. 12a.

In FIG. 12a, with alternate mode selected, the arpeggiator will start by playing the highest note step, for the highest note order value, and then move to the next higher note order value and play the highest note step. This sequence will loop around, in note order value, playing the next highest note step in each note position. Alternate mode function will play, in different patterns and sequences when different play patterns are selected such as converge, diverge and random. When random is selected with alternate mode, novel and compelling note patterns can be developed quickly and easily. An indicator 54, as shown in FIG. 10, is presented to identify the note step currently playing in the configured pattern. FIG. 12b displays a table showing the note play pattern resulting from the alternate mode configuration in FIG. 12a.

According to embodiments of the present invention, the software application provides the facility to configure a selected chord to play in rhythmic patterns and sequences, as shown in FIG. 13. When 30 is selected, as per FIG. 7, the software application will take the notes as configured in FIG. 9a, and play them together, as a chord, as configured in the user interface FIG. 13, in patterns and sequences, applying the associated control settings and adjustments.

With reference to FIG. 13, there is shown a user interface of a system for facilitating music composition and performance according to embodiments of the invention, generally referred to herein by reference numeral 1300.

FIG. 13 shows an example of a user interface showing settings, controls and adjustments to allow the notes of a selected chord to be played simultaneously in patterns and sequences. A chord can also be transposed using the same settings as those shown for an arpeggio.

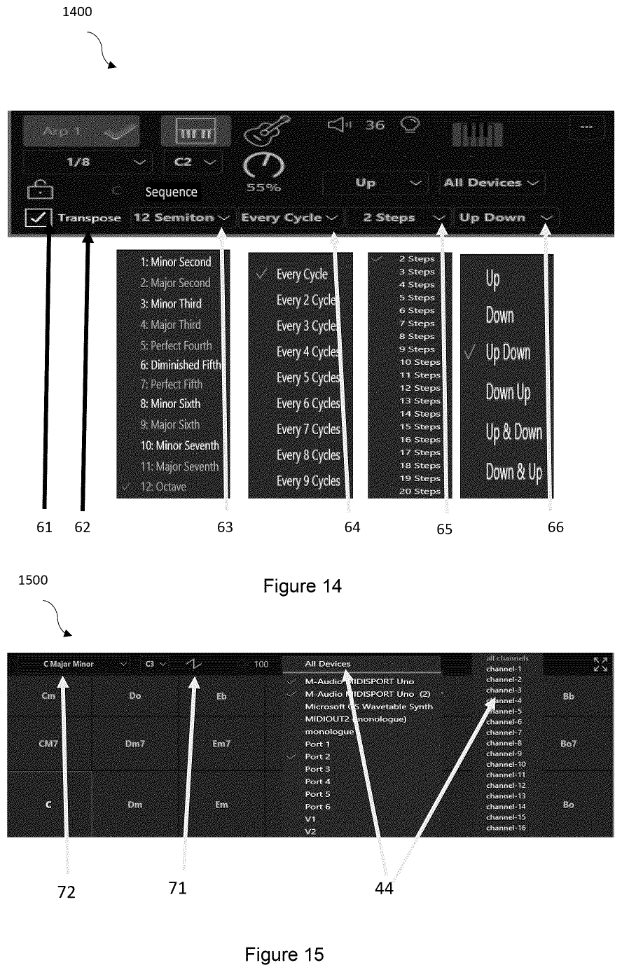

In FIG. 13, according to embodiments of the present invention, the software application presents a user interface chord pattern configurator to allow the notes, configured in FIG. 9a, be played simultaneously as a chord. Notes that are deactivated or muted in FIG. 9a will not be played as a chord in this selection. In FIG. 7, selecting the chord pattern configurator shown in FIG. 13, facilitates the setup and configuration of multiple playing steps for selected chord elements, showing associated settings, controls and adjustments, to create playing patterns and sequences for the chord. Individual steps, 41, can be selected from the dropdown menu associated with FIG. 8a. Chords will play with the controls and settings assigned to the individual steps. Settings and controls for individual chord steps include, as an example: mute 101, volume 102, solo 103, gate 104 and note active selection 55. A rest/silence is played when a step is active and is muted, or has its volume set to zero. Additional chord pattern steps 12 can be added. Chord pattern steps can be removed 10. With reference to FIG. 14, there is shown a user interface of a system for facilitating music composition and performance according to embodiments of the invention, generally referred to herein by reference numeral 1400.

FIG. 14 shows an example of an arpeggiator user interface pane showing settings, controls and adjustments together with the dropdown selection menus available to allow the arpeggio, running in the pane, be transposed. These settings and controls are used to transpose the arpeggio running in the arpeggiator pane.

In FIG. 14, according to embodiments of the present invention, the software application provides the option to apply transitions to an arpeggio configured in an arpeggio pane. An arpeggio configured in FIG. 8, has its individual notes played in patterns and sequences within the pitch range selected 42. Transposition moves an arpeggio in different patterns, in different interval values, in selectable cycles. Transposition of arpeggios simulates playing virtuosity, produces note movement and flow, adds flair, colour, variety and depth to beat creation and instrumental soloing. It is an invaluable tool for beat creation, as MIDI notes transposed by small intervals, in the octave range associated with percussive instruments, produce very complex, novel, and appealing beat combinations using multiple instrument sounds. Guitar solos are commonly played as arpeggios that cycle across several octave ranges, at different note interval values, using different note patterns and sequences.

When transposition 61 is engaged, as shown in FIG. 14, the transposition selection features are highlighted, namely: transposition active 62, transition interval 63, number of cycles played before transitioning 64, number of transition steps to cover 65 and transition patterns 66. Transposition generally means shifting the pitch of a note by an interval value. In this arpeggio implementation, the software application automatically shifts the arpeggio notes by an interval value, in selected cycles, in the selected pattern for the selected number of steps. An arpeggio, as configured with reference to FIG. 8a, will be transposed by the intervals value 63, play for a selected number of cycles 64, for the number of selected interval steps 65, in the selected pattern 66. With different interval settings selected 63, transpositions can provide tension and variety to arpeggios, as some notes from outside the selected key can be seamlessly introduced into an arpeggio.

Chord patterns, as configured in FIG. 13, can be transposed using the same configuration setup as described for arpeggio transpositions with reference to FIG. 14.

With reference to FIG. 15, there is shown a user interface of a system for facilitating music composition and performance according to embodiments of the invention, generally referred to herein by reference numeral 1500.

FIG. 15 shows example of a chord selection matrix area showing settings, controls, and adjustments together with the dropdown selection menus available to allow the MIDI data stream associated with the selected chord notes be played together with the arpeggios running in the arpeggio areas and to route this MIDI data stream to any port or selected device destination.

A music composition has a structure that is broken into bars. When composing or performing, it is most important to know where a beat is positioned in a specific bar number. A traditional metronome provides just an audible sound at the onset of a beat and nothing else. Audible beat indicators do not inform the artist where that beat is occurring in time. The performer must count beats with their associated bar number to know their position within the song structure.

With reference to FIG. 16, there is shown a user interface of a system for facilitating music composition and performance according to embodiments of the invention, generally referred to herein by reference numeral 1600.

FIG. 16a shows an example of a user interface showing a visual metronome where the software application will synchronise chord changes effected in the chord selection matrix with the occurrence of a downbeat or any beat.

FIG. 16b and FIG. 16c further shows an example of a user interface showing a visual metronome displaying beats and bars, time signature, and beat markers with their associated configuration selections according to embodiments of the present invention.

According to embodiments of the present invention, a visual metronome user interface, FIGS. 16a, 16b and 16c, is provided to inform the user of the exact position of a beat occurring within a specific bar.

The disclosed visual metronome is represented in FIG. 16a, where a visual beat indicator 54 scrolls across the bar timeline, at the selected tempo, to advise the exact beat position within a specific bar number in real-time.

FIG. 16a shows, as an example, a visual metronome including the following: bar boundaries 1, beat positions within each bar 5, scrolling beat indicator 54, time signature selection 2, bar display configuration 3, sync chord changes to downbeat 4, sync chord changes to any beat 6, no sync or free run 7 and prime metronome to start on first chord selection 8.

At launch, the metronome is defaulted to display four bars in the most popular time signature of 4/4 time, also known as common time. A drop-down menu is then provided to select the number of bars to be displayed 3, as shown in FIG. 16 b. Based on the user selection, the software application will reconfigure the displayed metronome to reflect any selection changes to be applied.

With reference to FIG. 16c, a time signature dropdown selection menu 2, as shown in FIG. 16c, is provided to change the time signature presented in the metronome. The software application will reconfigure the displayed metronome to reflect the time signature selection changes applied. The time signature is represented by two numbers, one above the other. The time signature informs how notes are grouped together in a composition. The top number identifies the number of notes that are grouped in a bar. The bottom number identifies the type of notes (note quality) that are in the group.

The visual metronome presents a beat marker 54, as shown in FIG. 16a, that scrolls in sync with the selected tempo.

The first beat within a bar (generally called a downbeat) 1, as shown in FIG. 16a, is identified by a vertical line with other beats within a bar represented by a small circle 5.

According to embodiments of the present invention, as shown in FIGS. 16a and 16c, the visual metronome user interface provides the option to synchronise chord element selection changes and arpeggios note and pattern changes to occur on a downbeat 4, or the occurrence of any beat 6, or to disable beat synchronisation 7.

Many experienced musicians have difficulty timing chord changes on the downbeat or on any beat. To ensure accurate chord changes on the downbeat or on any beat, when option 4, as shown in FIG. 16a, is selected, the software application will automatically synchronise chord element selections to occur on the next downbeat. More experienced performers may wish to change chords without beat synchronisation by selecting the free run option 7 as shown in FIG. 16a.

In FIG. 16a, a prime option 8 is displayed which stops the metronome running and arms it to start when the next chord element selection is selected. This ensures that all chord element selections and arpeggio notes and patterns will start playing together, in sync, immediately on the first downbeat, of the first bar 1, shown in FIG. 16a, and remain in sync for all further chord element selections.

With reference to FIG. 17, there is shown a user interface of a system for facilitating music composition and performance according to embodiments of the invention, generally referred to herein by reference numeral 1700.

FIG. 17a shows an example of a user interface showing the means to capture, display and play chord progressions with scale degree position identifiers according to embodiments of the present invention.

FIG. 17b further shows an example of a user interface showing the means to capture, display and play chord progressions with chord name identifiers according to embodiments of the present invention.

In FIGS. 17a, 17b, according to embodiments of the present invention, the software application presents a user interface, as an example, which captures chord progressions. When composing, the starting point for any composition can be the discovery of a great chord progression. When creating, users may randomly select chord elements until they develop a chord progression that sounds good. As this chord element selection is a random process, it can be difficult to replicate it exactly afterwards. In this therefore important that the software application will automatically capture all chord element selections, in real-time, so that any chord progressions that are developed can be recalled, displayed and replayed immediately.

For any chord selection matrix, as shown in FIG. 15, each chord element has a row (x) and a scale degree position (y). The x, y co-ordinates for a chord element selection can be seamlessly transported to the corresponding x, y co-ordinates of any chord selection matrix layout for another key.

When capture chord progression 38 is selected, with reference to FIG. 5b, a user interface, as shown in FIG. 17a, is displayed which is associated with the visual metronome. With capture chord progression engaged, the software application provides the facility to record, display and play chord progressions that were created by the selection of chord elements in a chord selection matrix. When 65 is engaged, the captured chords will be displayed in their scale degree positions, along co-ordinate y. Capture chord progression 38 displays a timeline user interface and as shown in FIGS. 17a and 17b, three rows are shown. In this regard, each captured chord element selection is represented as a scale degree colour coded block 61, along co-ordinate y, positioned on one of the rows that corresponds to its x co-ordinate. A chord block has a commencement position and a play length, identified by a bar and beat position.

Optionally, when 66 in FIG. 17 a is selected, the chord names are displayed on a block. With reference to FIG. 17b, the chord name 12 which displayed is the name on file, for the x, y co-ordinates of the chord selection matrix of the currently selected key 72, as shown in FIG. 15. If a key is changed, the chord block name 12 changes to correspond with the x, y names associated with the selected key in terms of the chord selection matrix naming convention.

In terms of the metronome time signature setting 2, as shown in FIG. 16c, the bars and beat grid configuration for the capture chord progression timeline is shown. In this regard, the Prime function, 16c label 8 is primed automatically, to start recording when “record progression” 64, as shown in FIG. 17a, is selected. The record 64 of chord element selections will commence when the next chord element is selected. Recording will continue to add bars in the timeline until the play/stop function 63, is selected. Selecting “prime” 8, as shown in FIG. 16c, will also re-arm the metronome to the first bar and await the first chord element selection. The go to start function 62 will also “prime” the chord progression timeline and the metronome. The reset function 67 will clear the displayed progression and presents a blank, primed, timeline configuration.

With reference to FIGS. 17a and 17b, according to embodiments of the present invention, when MIDI play 34 is selected, the software application will play the displayed progression in sync with the metronome playing and will output a MIDI stream that simulates the manual selection of the chord element associated with the chord progression. The MIDI stream that is generated feeds automatically into the arpeggiators. With MIDI play 34 disabled, the captured chord progression is displayed with no MIDI play simulation.

A chord progression can be saved 31, and a saved progression can be recalled 32. When a saved progression is recalled 32, the chord progression timeline and the metronome will automatically “prime” and be ready to start playing from the downbeat of the first bar immediately upon the play button being pressed. If a key is changed in a saved progression 31, the chord names assigned to each block will be relabelled automatically to match the chord selection matrix layout of the new key.

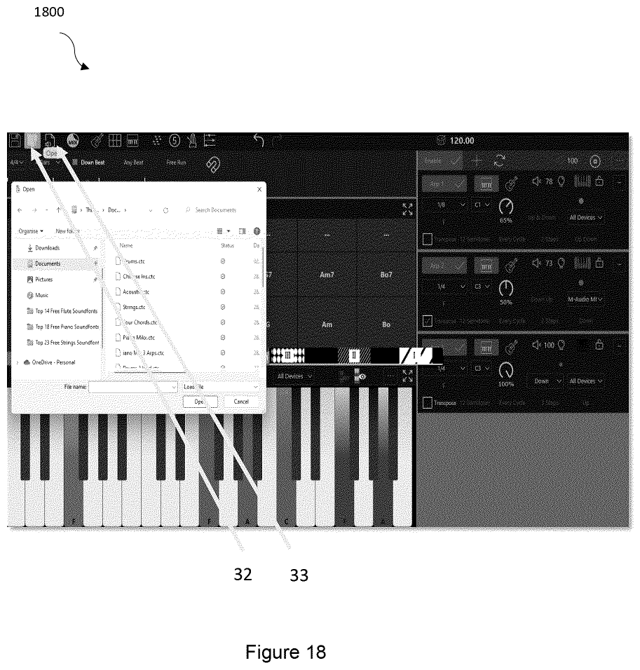

With reference to FIG. 18, there is shown a user interface of a system for facilitating music composition and performance according to embodiments of the invention, generally referred to herein by reference numeral 1800.

FIG. 18 shows, as an example, the facility of saving and opening a creation template which is assigned to a tab, according to embodiments of the present invention.

FIG. 18, according to embodiments of the present invention, displays a user interface associated with a creation tab, together with its settings, controls, adjustments, menu selections, associated windows, and dropdown selections which can be saved and recalled. When a user selects 33, as shown in FIG. 18, a creation tab will be saved. Upon selecting 32, a saved creation tab will be recalled.

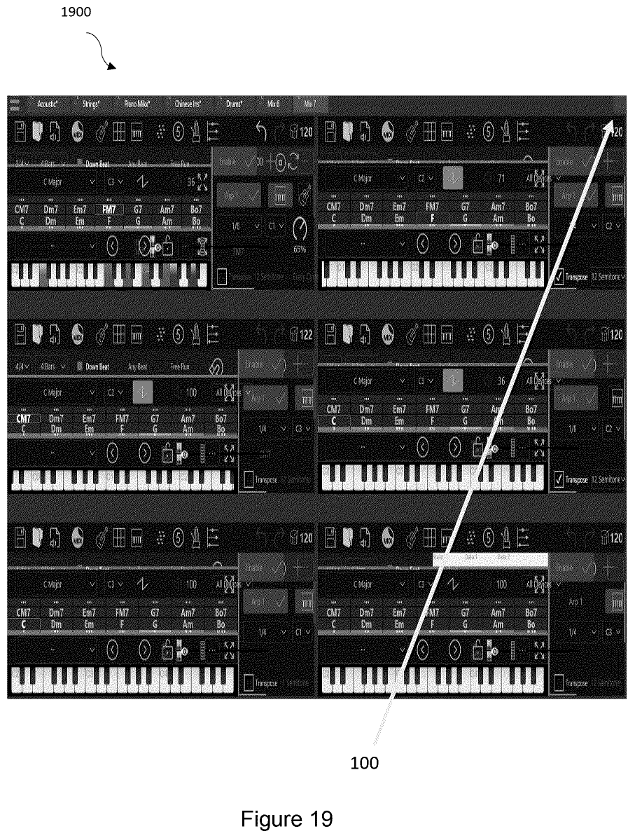

With reference to FIG. 19, there is shown a user interface of a system for facilitating music composition and performance according to embodiments of the invention, generally referred to herein by reference numeral 1900.

FIG. 19 shows the current open tabs all being displayed together in a tile layout.

FIG. 19 according to embodiments of the present invention, a displayed user interface shows the current creation tabs, displayed in a tile layout. In this tile layout, a user can move between tiles and make selections and adjustments in the individual displayed tile areas and play selections from a tile.

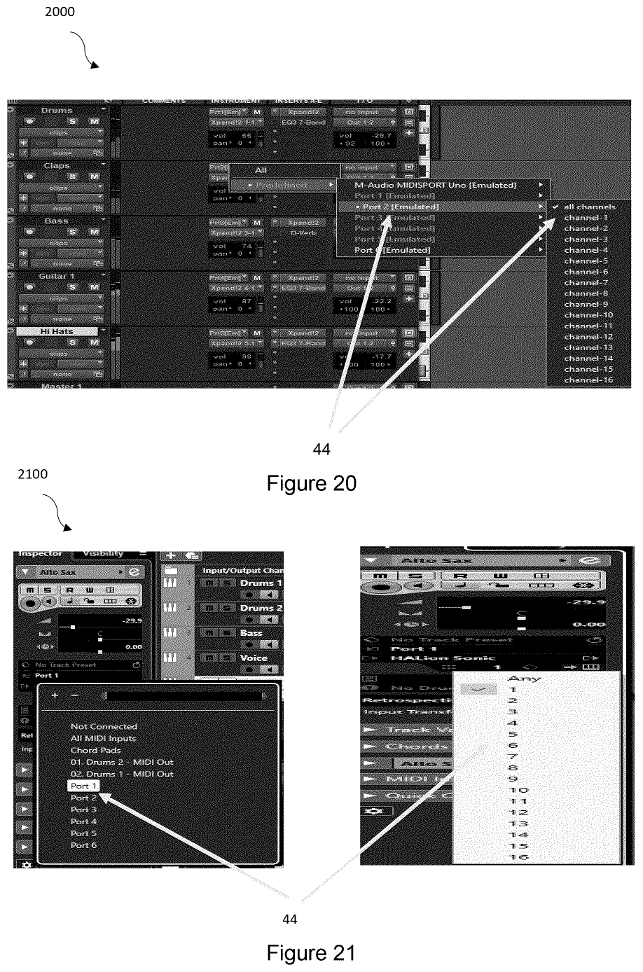

With reference to FIG. 20, there is shown a user interface of a system for facilitating music composition and performance according to embodiments of the invention, generally referred to herein by reference numeral 2000.

FIG. 20 shows, as an example, port and channel configuration selections for individual instruments and MIDI tracks supported in Avid Pro Tools™ DAWs, that can be selected to correspond with specific routing selections that have been configured.

FIG. 20 shows, as an example, port and channel configuration selections for individual instruments and MIDI tracks that are supported in Avid Pro Tools™ DAWs, independently paired with routing selections for independent creation areas that have been configured.

With reference to FIG. 21, there is shown a user interface of a system for facilitating music composition and performance according to embodiments of the invention, generally referred to herein by reference numeral 2100.

FIG. 21 shows, as an example, port and channel configuration selections for individual instruments and MIDI tracks supported in Cubase™ DAWs, that can be selected to correspond with routing selections that have been configured.

FIG. 21 shows, as an example, port and channel configuration selections for individual instruments and MIDI tracks supported in Cubase™ DAWs, that have been independently paired with routing selections for independent creation area configurations.

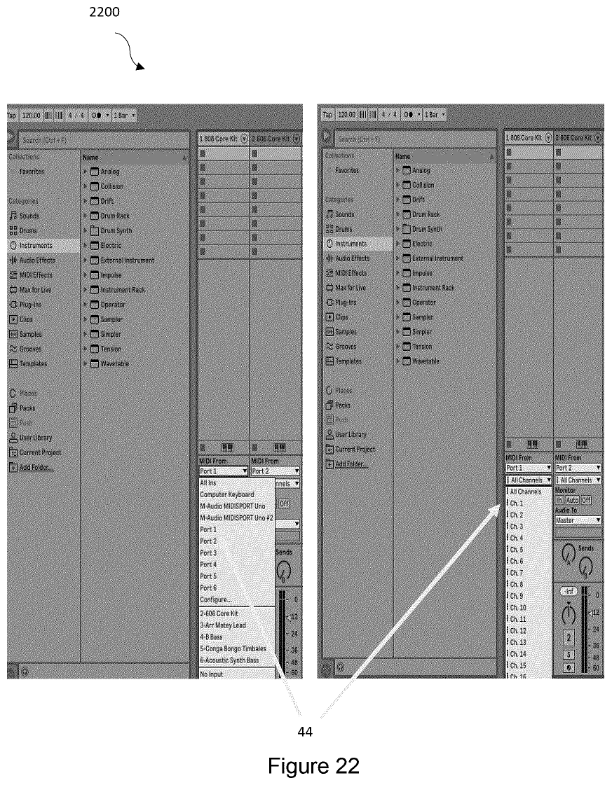

With reference to FIG. 22, there is shown a user interface of a system for facilitating music composition and performance according to embodiments of the invention, generally referred to herein by reference numeral 2200.

FIG. 22 shows, as an example, port and channel configuration selections for individual instruments and MIDI tracks supported in an Ableton Live™ DAWs, that can be selected to correspond with specific routing selection configurations.

FIG. 22 shows, as an example, port and channel configuration selections for individual instruments and MIDI tracks supported in Ableton Live™ DAWs, that have been independently paired with specific routing selections for independent creation area configurations.

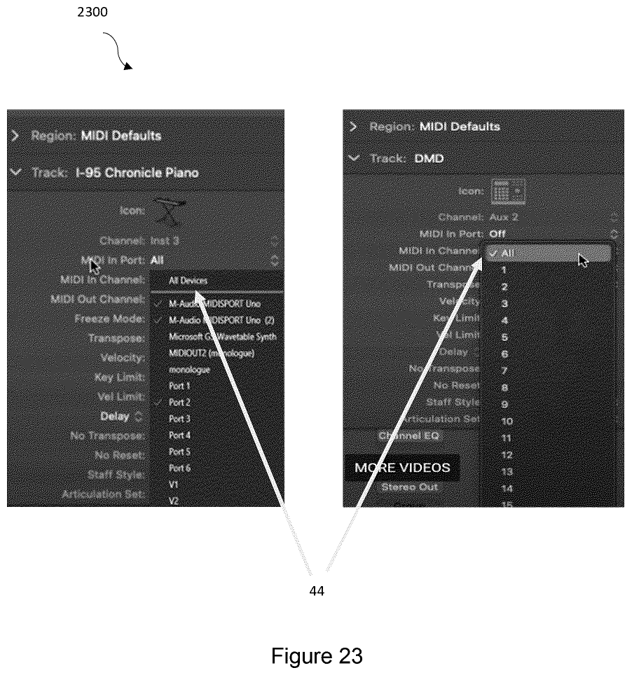

With reference to FIG. 23, there is shown a user interface of a system for facilitating music composition and performance according to embodiments of the invention, generally referred to herein by reference numeral 2300.

FIG. 23 shows as an example, port and channel configuration selections for individual instruments and MIDI tracks supported in an Apple Logic Pro x™ DAW, that can be selected to correspond with routing specific selection configurations.

FIG. 23 shows as an example, port and channel configuration selections for individual instruments and MIDI tracks supported in an Apple Logic Pro x™ DAW, that can be independently paired with routing selections for independent creation area configurations. The software application disclosed can independently pair the instrument or MIDI tracks of a DAW, with routing selections for independent creation areas configured in the disclosed software application, if the facility is supported in the DAW.

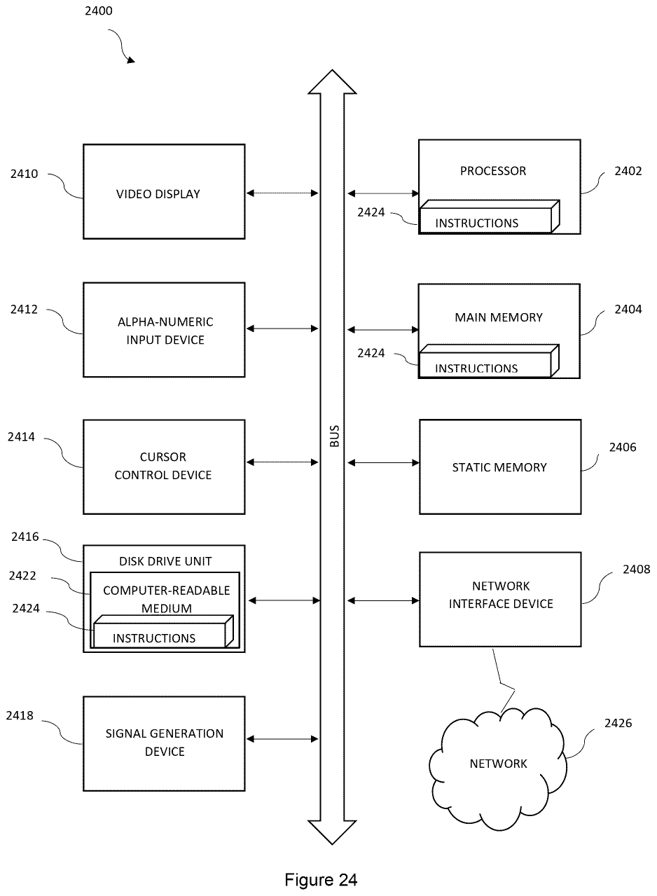

FIG. 24 shows a computer system within which a set of instructions may be executed for causing the computer to perform any one or more of the methodologies described herein.

In FIG. 24, a computer is shown within which a set of instructions may be executed for causing the computer to perform any one or more of the methodologies described herein. In embodiments, these instructions are executed within the context of a software application.

In FIG. 24, in accordance with some embodiments, a computer 2400 is disclosed which comprises: one or more processors; and a non-transitory computer-readable memory having stored therein computer-executable instructions, that when executed by the one or more processors, cause the one or more processors to perform actions described herein.

In a networked deployment, computer 2400 may operate in the capacity of a server or a client machine in server-client network environment, or as a peer machine in a peer-to-peer (or distributed) network environment. Computer 2400 may be a personal computer (PC), a tablet, a set-top box (STB), a personal digital assistant (PDA), a cellular telephone, a web appliance, a network router, switch or bridge, or any computer 2400 capable of executing a set of instructions (sequential or otherwise) that specify actions to be taken by that computer 2400. Further, while only a single computer 2400 is illustrated, the term “computer” shall also be taken to include any collection of computers that individually or jointly execute a set (or multiple sets) of instructions to perform any one or more of the methodologies discussed herein.

The example computer system 2400 includes a processor 2402 (e.g., a central processing unit (CPU), a graphics processing unit (GPU) or both), a main memory 2404 and a static memory 2406, which communicate with each other via a bus. The computer 2400 may further include a video display unit 2410 (e.g., a liquid crystal display (LCD)). Computer 2400 may also include an alphanumeric input device 2412 (e.g., a keyboard), a user interface (UL) navigation device 2414 (e.g., a mouse), a disk drive unit 2416, a signal generation device 2418 (e.g., a speaker) and a network interface device 2408.

The disk drive unit 2416 includes a computer-readable medium 2422 on which is stored one or more sets of instructions and data structures (e.g., a software application 2424) embodying or utilising any one or more of the methodologies or functions described herein. Software 2424 may also reside, completely or at least partially, within the main memory 2404 and/or within the processor during execution thereof by the computer system 2400, the main memory and the processor also constituting computer-readable media. To this end, for clarity, please note that where the software 2424 is not located in the main memory 2404 and/or within the processor during execution thereof by the computer system 2400, it will be in a cloud-based or remote storage location and may be executed directly from there.

The software 2424 may further be transmitted or received over a network 2426 via the network interface device 2420 utilising any one of several well-known transfer protocols (e.g., http, FTP).

In some embodiments the computer-readable medium 2422 for carrying out the above-mentioned technical steps of the framework's functionality, is non-transitory in nature. The non-transitory computer-readable medium 2422 has tangibly stored thereon, or tangibly encoded thereon, software 2424 that when executed by a device (e.g., application server, messaging server, email server, ad server, content server and/or client device, and the like) cause at least one processor to perform a method of facilitating music creation and performance. In accordance with one or more embodiments, a system is provided that comprises one or more computer systems 2400 configured to provide functionality in accordance with such embodiments. In accordance with one or more embodiments, functionality is embodied in steps of a method performed by at least one computer. In accordance with one or more embodiments, software 2424, program code (or program logic) executed by a processor(s) of a computer system 2400 to implement functionality in accordance with one or more such embodiments is embodied in, by and/or on a non-transitory computer-readable medium 2422.

While the computer-readable medium 2422 is shown in an example embodiment to be a single medium, the term “computer-readable medium” should be taken to include a single medium or multiple media (e.g., a centralised or distributed database, and/or associated caches and servers) that store the one or more sets of instructions. The term “computer-readable medium” shall also be taken to include any medium that is capable of storing, encoding or carrying a set of instructions for execution by the computer system 2400 and that cause the computer system 2400 to perform any one or more of the methodologies of the present embodiments, or that is capable of storing, encoding or carrying data structures utilised by or associated with such a set of instructions. The term “computer-readable medium” shall accordingly be taken to include, but not be limited to, solid-state memories and optical and magnetic media as well as cloud storage options (such as Amazon Webservices™, Microsoft Azure™, and the like).

It is to be understood that the invention is not limited to the specific details described herein and which are given by way of example only and that various modifications and alterations are possible without departing from the scope of the invention.

1. A system for facilitating music composition and performance, including one or more of the following:
a chord selection matrix area, operatively configured to receive and assign notes of a selected chord, said selected chord representing a scale degree position and chord value within a calculated musical key or key combination;
a plurality of arpeggiator panes associated with said chord selection matrix area, each arpeggiator pane being operatively configured to receive the assigned notes of said selected chord, wherein said assigned notes are arranged in patterns and sequences to generate one or more melodies, harmonies, beats, or instrument solos;
an interactive and real-time adjustment means operable to enable modification of note patterns and sequences applied to said selected chord notes; and
a routing mechanism, operable to route the MIDI data stream originated from any individual creation area to independently pair with an individual instrument or Musical Instrument Digital Interface (MIDI) track in a Digital Audio Workstation (DAW) running locally, or independently pair with an individual track of a connected external MIDI-capable device for simultaneous playback.

2. A system as claimed in claim 1, wherein the system is operable to multitask with a DAW running on the same device, so to as provide the ability to route the MIDI data stream generated by chord selection, virtual instrument note playing, or arpeggio running to independently paired virtual instrument tracks of a DAW or to a connected external MIDI-enabled playing device.

3. A system as claimed in claim 1, wherein the routing mechanism is operable to enable a MIDI data stream to be individually routed through the selection of a chord in the chord selection matrix, the selection of notes in the virtual instrument area or within the MIDI stream generated by an arpeggio running in an individual arpeggiator pane, to an independently paired instrument or MIDI-track of a DAW.

4. A system as claimed in claim 1, wherein the method simulates multiple external MIDI keyboards, multiple external MIDI sequencers and multiple external MIDI drum machines, playing individual instruments or MIDI tracks of a DAW.

5. A system as claimed in claim 1, wherein the MIDI data streams may be associated with one or more of the following: an individual arpeggiator pane with an individual instrument or MIDI track of a Digital Audio Workstation (DAW), a selected chord in the chord selection matrix area, one or more control member activations in a virtual instrument playing area, a MIDI track of a locally running DAW, or an individual track of a connected external MIDI-capable device.

6. A system as claimed in claim 1, wherein the chord selection matrix area may include a visual metronome, operable to provide synchronization options for chord changes, arpeggio patterns, or instrument activations with a selected beat such as a downbeat, to enhance rhythmic precision within a music composition.

7. A system as claimed in any claim 1, wherein the arpeggiator panes include a play-through feature allowing simultaneous playback of notes from a selected chord in the chord selection matrix area and arpeggios in the arpeggiator panes, to facilitate composition evaluation.

8. A system as claimed in claim 1, wherein the interactive and real-time adjustment means includes a visual interface operable to display one or more of the following: note configurations, chord progressions, or arpeggio configurations, to enable dynamic modification during music composition and performance.

9. A system as claimed in claim 1, wherein the distribution of assigned notes to arpeggiator panes allows configuration and arrangement of patterns and sequences for generating novel and compelling melodies, harmonies, beats, or instrument solos with rhythm, movement, flow, variety, and interest.

10. A system as claimed in claim 1, wherein the routing mechanism provides a versatile MIDI destination configuration, to enable a selection of virtual MIDI ports, MIDI channels, or recognized MIDI destinations for independent pairing with specific instrument or MIDI tracks, to enhance collaboration and interoperability.

11. A system as claimed in claim 1, wherein the system further includes a means to route the MIDI data stream originated from any individual creation area to independently pair with an individual instrument or MIDI tracks in a DAW running locally, or independently pair with individual tracks of connected external MIDI-capable devices for simultaneous playback.

12. A system as claimed in claim 1, wherein the system is operable to run on a tablet, smartphone, or other mobile device, communicating with one or multiple devices running a DAW, and providing the facility to route MIDI data streams from each creation area to independently paired individual instruments or MIDI tracks of the DAWs running on these devices, to enable multiple users to collaborate in real-time.

13. A system as claimed in claim 1, wherein the system includes a sync to downbeat means, operable to ensure that chord changes which are initiated by a user in the chord selection matrix are applied in synchronisation with the occurrence of a downbeat, which is the first beat in a bar, or on any beat occurrence, and in turn this synchronisation of chord changes to the downbeat enables patterns and/or sequences applied to individual notes configured and applied in the individual arpeggiator areas to be maintained in a correct play order when chord changes occur.

14. A system as claimed in claim 13, wherein the sync to downbeat means is operable to enable chord changes applied in the chord selection matrix to stay on the beat.

15. A system as claimed in claim 1, wherein the system further includes a visual metronome window operable to accommodate a time signature selection, a bar and beat position indicator, displaying a scrolling cursor identifying the current play position of a beat within a specific bar and within a section of a composition.

16. A system as claimed in claim 1, wherein the system includes a visual metronome display area which provides synchronization options for chord changes, arpeggio patterns, or instrument activations with a selected beat, enhancing rhythmic precision within a music composition.

17. A system as claimed in claim 16, wherein the visual metronome display area enables chord changes applied in the chord selection matrix to be synchronized with the onset of a downbeat, or with any beat occurrence, to ensure patterns and sequences applied to individual notes in arpeggiator areas remain in sync during chord changes.

18. A system as claimed in claim 1, wherein the system includes a user experience (UX) interface, operable to enable assistance of users, at all levels of music experience, to create complex music compositions, almost instantaneously, whilst they absorb the music concepts essential to longer-term composition and creation success.

19. A system as claimed in claim 18, wherein the user experience (UX) interface is operable to assists users to independently play any virtual instrument or MIDI track in a DAW.

20. A computer-implemented method for music composition and performance, including one or more of the following steps:
displaying a chord selection matrix template associated with a musical key or a key combination;
assigning one or more notes, associated with a chord element selected from the chord selection matrix, to activate one or more control functions or activation control members of a virtual instrument;
playing one or more audio sounds of a digital musical file, associated with an individual note assigned to the selected chord element;
displaying an arpeggiator area with a master control pane and multiple individual arpeggio panes associated with the selected digital musical file;
assigning notes associated with the selected chord element to arpeggio panes and arranging them in patterns and sequences for playback;
displaying an arpeggio configuration window and a notes configuration window for interactive and real-time modification of arpeggio and note patterns during music composition and performance; and
providing a versatile MIDI destination configuration, enabling the selection of virtual MIDI ports, MIDI channels, or recognized MIDI destinations for independent pairing with a specific instrument or MIDI track.

21. A method as claimed in claim 20, wherein the method includes one or more of the following steps:
displaying a visual metronome area for synchronization options of chord changes, arpeggio patterns, or instrument activations with a selected beat;
synchronizing chord changes with a downbeat or any beat occurrence to ensure patterns and sequences in arpeggiator areas remain in sync during chord changes;
providing a prime function to arm the metronome to play on the first chord selection in the chord selection matrix;
recording, displaying, and playing chord progressions developed through the selection of chord elements in the chord selection matrix; and
displaying a MIDI destination routing configuration area to show available MIDI playing destinations, devices, on-board virtual instrument destinations, and associated controls, settings, and adjustments.

22. A computer system for facilitating music composition and performance, including one or more of the following:
a screen display device;
one or more data processors;
one or more non-transitory computer-readable storage media containing instructions for a computer software application to perform one or more of the following tasks:
displaying a chord selection matrix template on a first region of the screen device, associated with a musical key or key combination,
assigning notes associated with the selected chord element to activation control members of the virtual instrument,
playing audio sounds associated with the selected chord element,
displaying an arpeggiator area with a master control pane and multiple individual arpeggio panes associated with a selected digital musical file,
assigning notes associated with the selected chord element to arpeggio panes for arrangement in patterns and sequences,
displaying an arpeggio configuration window and a notes configuration window for interactive and real-time modification of arpeggio and note patterns,
providing a versatile MIDI destination configuration for independent pairing with specific instrument or MIDI tracks in a DAW or external MIDI-capable device.

23. A computer system as claimed in claim in 22, wherein the non-transitory computer-readable storage media contains instructions for a computer software application to perform one or more of the following tasks:
displaying a visual metronome area for synchronization options of chord changes, arpeggio patterns, or instrument activations with a selected beat, the metronome area including a prime function to arm the metronome to enable play on the first chord selection in the chord selection matrix, the metronome area being operable to record, display, and play chord progressions developed through the selection of chord elements,
displaying a visual metronome window with sync to a beat such as a downbeat, or free run selection,
displaying a MIDI destination routing configuration area to show available MIDI playing destinations, devices, on-board virtual instrument destinations, and associated controls, settings, and adjustments, and
displaying multiple advanced arpeggiator areas, chord selection matrix areas, virtual instrument playing areas, and a MIDI destination routing configuration area.
